(19) United States
(12) Patent Application Publication
(10) Pub. No.: US 2011/0170605 A1
(43) Pub. Date: Jul. 14, 2011

(54) IMAGE PROCESSING APPARATUS AND IMAGE PROCESSING METHOD

(76) Inventors: Kazushi Sato, Kanagawa (JP); Yoichi Yagasaki, Tokyo (JP)

(21) Appl. No.: 13/119,723

(22) PCT Filed: Sep. 24, 2009
(86) PCT No.: PCT/JP2009/066488

§ 371 Date: Mar. 18, 2011

(30) Foreign Application Priority Data
Sep. 24, 2008 (JP) 2008-243957

(51) Int. Cl. H04N 7/12

(52) U.S. Cl. 375/240.16; 375/E07.115; 375/E07.123; 375/E07.243

(57) ABSTRACT

The present invention relates to an image processing apparatus and an image processing method capable of preventing an increase in the amount of computation. An L1 search center computing unit 77 computes a motion search center of an L1 reference frame using a motion vector tmmv_{L0} searched for in an L0 reference frame, a distance t_{L0} between a target frame and the L0 reference frame on a time axis t and a distance t_{L1} between the target frame and the L1 reference frame on the time axis t. A template motion prediction/compensation unit 76 performs a motion search within a predetermined area E_{L1} around the search center of the L1 reference frame computed by the L1 search center computing unit 77, performs a compensation process, and generates a predicted image. The present invention is applicable to an image encoding apparatus that performs encoding using, for example, the H.264/AVC standard.

### TECHNICAL FIELD

The present invention relates to an image processing apparatus and an image processing method and, in particular, to an image processing apparatus and an image processing method that prevent an increase in the amount of computation.

### BACKGROUND ART

In recent years, a technology for compression-encoding an image using a compression-encoding method, such as MPEG (Moving Picture Experts Group) 2 or H.264 and MPEG-4 Part 10 (Advanced Video Coding) (hereinafter referred to as “H.264/AVC”), packetizing and transmitting the image, and decoding the image at the receiving end has been widely used. Thus, users can view a high-quality moving image.

In addition, in the MPEG2 standard, a motion prediction/compensation process with ½-pixel accuracy using a linear interpolation process is performed. In contrast, in the H.264/AVC standard, a motion prediction/compensation process with ¼-pixel accuracy using a 6-tap FIR (Finite Impulse Response Filter) filter is performed.

Furthermore, in the MPEG2 standard, in the case of a frame motion compensation mode, a motion prediction/compensation process is performed on per 16×16 pixel basis. In contrast, in the case of a field motion compensation mode, a motion prediction/compensation process is performed for each of first and second fields on per 16×8 pixel basis.

In contrast, in the H.264/AVC standard, a motion prediction/compensation process can be performed on the basis of a variable block size. That is, in the H.264/AVC standard, a macroblock including 16×16 pixels is separated into one of 16×16 partitions, 16×8 partitions, 8×16 partitions, and 8×8 partitions. Each of the partitions can have independent motion vector information. In addition, an 8×8 partition can be separated into one of 8×8 sub-partitions, 8×4 sub-partitions, 4×8 sub-partitions, and 4×4 sub-partitions. Each of the sub-partitions can have independent motion vector information.

However, in the H.264/AVC standard, when the above-described motion prediction/compensation process with ¼-pixel accuracy is performed on the basis of a variable block size, an enormous number of motion vector information items are disadvantageously generated. If these motion vector information items are directly encoded, the efficiency of encoding is decreased.

Accordingly, a technique for searching within a decoded image for a region of the image having a high correlation with a decoded image of a template region, which is part of the decoded image and adjacent to the image of a region to be decoded with a predetermined positional relationship, and performing prediction on the basis of the searched region and the predetermined positional relationship has been proposed (refer to PTL 1).

In this technique, a decoded image is used for matching. Accordingly, by predetermining a search area, the same process can be performed in an encoding apparatus and a decoding apparatus. That is, by performing the above-described prediction/compensation process in even the decoding apparatus, motion vector information need not be included in the image compression information received from the encoding apparatus. Therefore, a decrease in coding efficiency can be prevented.

### Citation List

### Patent Literature

PTL 1: Japanese Unexamined Patent Application Publication No. 2007-43651

### SUMMARY OF INVENTION

### Technical Problem

As noted above, the technique described in PTL 1 requires a prediction/compensation process in not only an encoding apparatus but also a decoding apparatus. In such a case, in order to obtain excellent coding efficiency, a search area having a sufficient size is needed. However, if the search area is increased, the amount of computation increases in not only the encoding apparatus but also the decoding apparatus.

In particular, in a B slice, a motion search is needed for List0 and List1. Therefore, the amount of computation significantly increases.

Accordingly, the present invention is intended to prevent an increase in the amount of computation.

### Solution to Problem

According to an aspect of the present invention, an image processing apparatus includes a motion prediction unit configured to search for a motion vector of a first target block of a frame using a template that is adjacent to the first target block with a predetermined positional relationship and that is generated from a decoded image and a search center computing unit configured to compute a search center of a List1 reference frame using motion vector information regarding the first target block searched for in a List0 reference frame by the motion prediction unit and time distance information between the frame and the List0 reference frame and between the frame and the List1 reference frame. The motion prediction unit searches, using the template, for the motion vector of the first target block within a predetermined search area around the search center of the List1 reference frame computed by the search center computing unit.

The search center computing unit can compute the search center of the List1 reference frame by scaling the motion vector information regarding the first target block searched for in the List0 reference frame by the motion prediction unit in accordance with the time distance information between the frame and the List0 reference frame and between the frame and the List1 reference frame.

The search center computing unit can compute the search center of the List1 reference frame by rounding off the scaled motion vector information regarding the first target block to an integer pixel accuracy.

POC (Picture Order Count) can be used as the time distance information.

The image processing apparatus can further include a decoding unit configured to decode encoded motion vector information and a second motion prediction compensation unit configured to generate a predicted image using a motion vector of a second target block of the frame decoded by the decoding unit.

The motion prediction unit can search for a motion vector of a second target block of the frame using the second target block, and the image processing apparatus can further include an image selection unit configured to select one of a predicted image based on the motion vector of the first target block searched for by the motion prediction unit and a predicted image based on the motion vector of the second target block searched for by the motion prediction unit.

According to an aspect of the present invention, an image processing method for use in an image processing apparatus is provided. The method includes a motion prediction step of searching for a motion vector of a target block of a frame using a template that is adjacent to the target block with a predetermined positional relationship and that is generated from a decoded image and a search center computing step of computing a search center of a List1 reference frame using motion vector information regarding the target block searched for in a List0 reference frame by the motion prediction unit and time distance information between the frame and the List0 reference frame and between the frame and the List1 reference frame. In the motion prediction step, the motion vector of the target block is searched for within a predetermined search area around the computed search center of the List1 reference frame using the template.

According to the aspects of the present invention, a motion vector of a target block of a frame is searching for using a template that is adjacent to the target block with a predetermined positional relationship and that is generated from a decoded image. In addition, a search center of a List1 reference frame is computed using motion vector information regarding the target block searched for in a List0 reference frame by the motion prediction unit and time distance information between the frame and the List0 reference frame and between the frame and the List1 reference frame. Furthermore, the motion vector of the target block is searched for within a predetermined search area around the search center of the List1 reference frame using the template.

### Advantageous Effects of Invention

According to the above-described aspect of the present invention, an image can be encoded and decoded. In addition, according to the above-described other aspect of the present invention, an increase in the amount of computation can be prevented.

### BRIEF DESCRIPTION OF DRAWINGS

FIG. 1 is a block diagram of the configuration of an image encoding apparatus according to an embodiment of the present invention.

FIG. 2 illustrates a variable-length block size motion prediction/compensation process.

FIG. 3 illustrates a motion prediction/compensation process with ¼-pixel accuracy.

FIG. 4 is a flowchart illustrating an encoding process performed by the image encoding apparatus shown in FIG. 1.

FIG. 5 is a flowchart illustrating a prediction process performed in step S21 shown in FIG. 4.

FIG. 6 is a flowchart illustrating an intra-prediction process performed in step S31 shown in FIG. 5.

FIG. 7 illustrates directions of intra prediction.

FIG. 8 illustrates intra prediction.

FIG. 9 is a flowchart illustrating an inter motion prediction process performed in step S32 shown in FIG. 5.

FIG. 10 illustrates an example of a method for generating motion vector information.

FIG. 11 is a flowchart illustrating an inter-template motion prediction process performed in step S33 shown in FIG. 5.

FIG. 12 illustrates an inter-template matching method.

FIG. 13 illustrates the processes performed in steps S71 to S73 shown in FIG. 11 in detail.

FIG. 14 is a block diagram of the configuration of an image decoding apparatus according to an embodiment of the present invention.

FIG. 15 is a flowchart illustrating a decoding process performed by the image decoding apparatus shown in FIG. 14.

FIG. 16 is a flowchart illustrating a prediction process performed in step S138 shown in FIG. 15.

FIG. 17 is a flowchart illustrating an inter-template motion prediction process performed in step S175 shown in FIG. 16.

FIG. 18 illustrates an example of an extended macroblock size.

FIG. 19 is a block diagram of an example of the primary configuration of a television receiver according to the present invention.

FIG. 20 is a block diagram of an example of a primary configuration of a cell phone according to the present invention.

FIG. 21 is a block diagram of an example of the primary configuration of a hard disk recorder according to the present invention.

FIG. 22 is a block diagram of an example of the primary configuration of a camera according to the present invention.

### DESCRIPTION OF EMBODIMENTS

Embodiments of the present invention are described below with reference to the accompanying drawings.

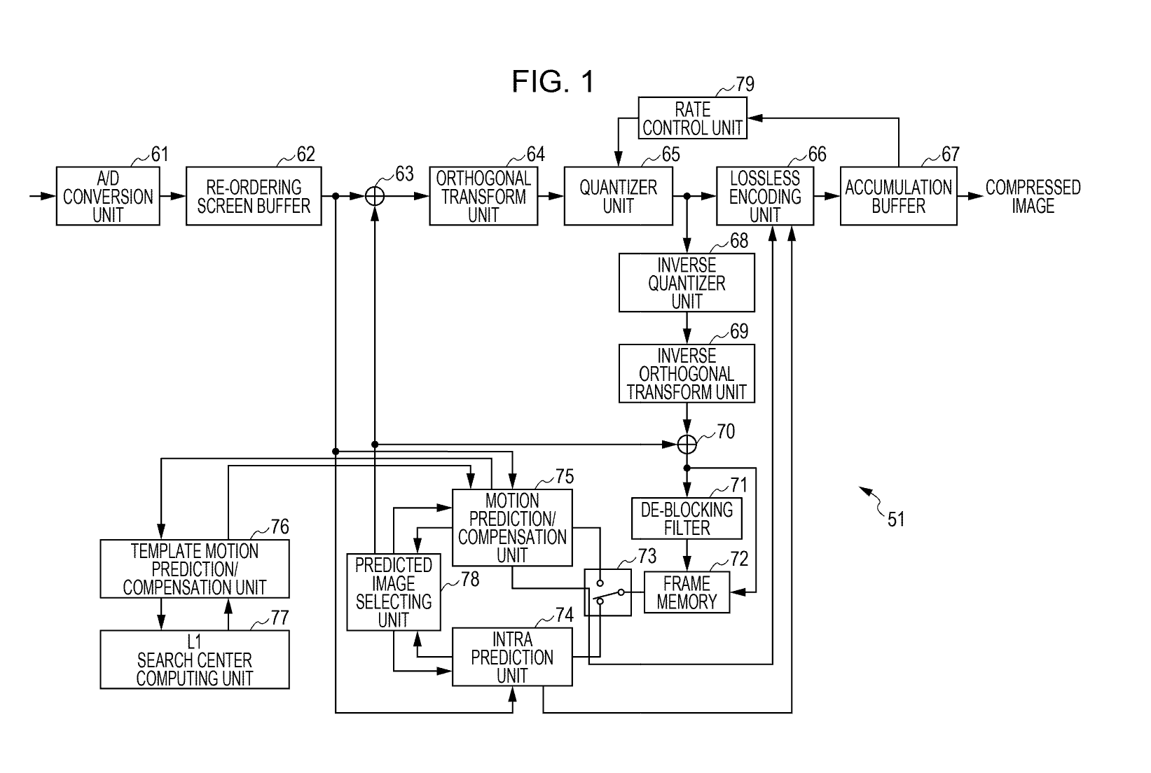

FIG. 1 illustrates the configuration of an image encoding apparatus according to an embodiment of the present invention. An image encoding apparatus 51 includes an A/D conversion unit 61, a re-ordering screen buffer 62, a computing unit 63, an orthogonal transform unit 64, a quantizer unit 65, a lossless encoding unit 66, an accumulation buffer 67, an inverse quantizer unit 68, an inverse orthogonal transform unit 69, a computing unit 70, a de-blocking filter 71, a frame memory 72, a switch 73, an intra prediction unit 74, a motion prediction/compensation unit 75, a template motion prediction/compensation unit 76, an L1 (List1) search center computing unit 77, a predicted image selecting unit 78, and a rate control unit 79.

The image encoding apparatus 51 compression-encodes an image using, for example, an H.264 and MPEG-4 Part 10 (Advanced Video Coding) (hereinafter referred to as “H.264/AVC”) standard.

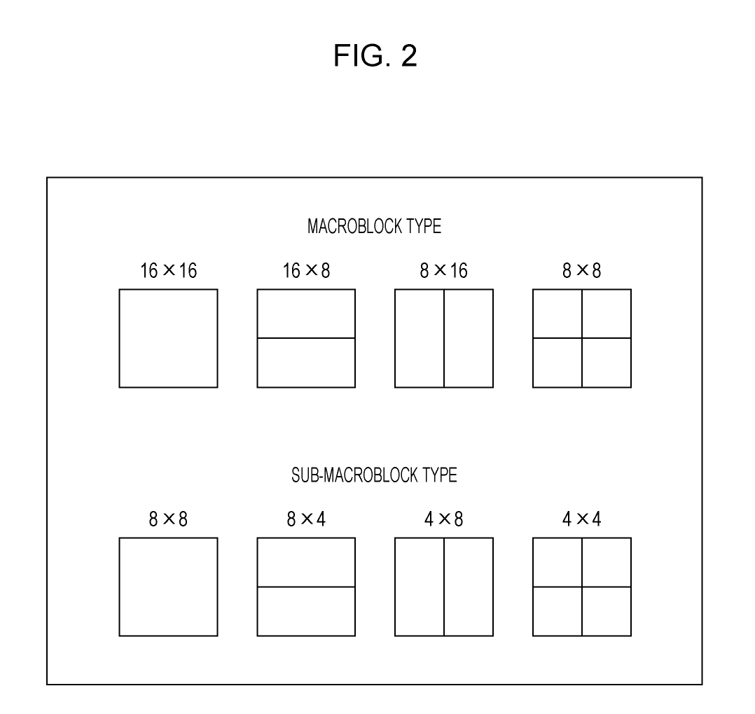

In the H.264/AVC standard, motion prediction/compensation is performed using a variable block size. That is, as shown in FIG. 2, in the H.264/AVC standard, a macroblock including 16×16 pixels is separated into one of 16×16 partitions, 16×8 partitions, 8×16 partitions, and 8×8 partitions. Each of the partitions can have independent motion vector information. In addition, as shown in FIG. 2, an 8×8 partition can be separated into one of 8×8 sub-partitions, 8×4 sub-partitions, 4×8 sub-partitions, and 4×4 sub-partitions. Each of the sub-partitions can have independent motion vector information.

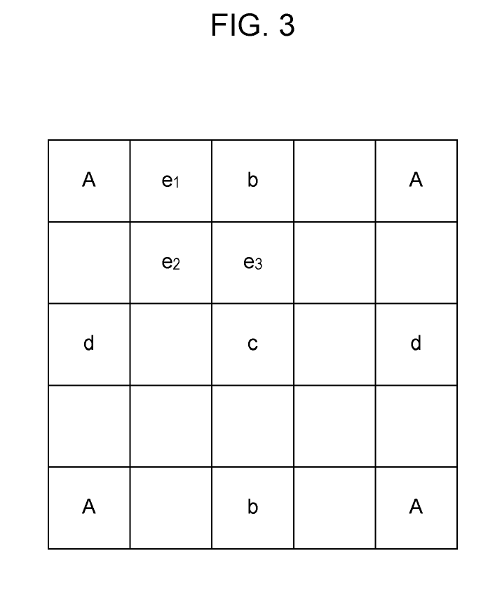

In addition, in the H.264/AVC standard, when a motion prediction and compensation process with ¼-pixel accuracy is performed using a 6-tap FIR (Finite Impulse Response Filter) filter. A prediction/compensation process with sub-pixel accuracy in the H.264/AVC standard is described next with reference to FIG. 3.

In an example shown in FIG. 3, positions A represent the positions of integer accuracy pixels, positions b, c, and d represent the positions of ½-pixel accuracy pixels, and positions e1, e2, and e3 represent the positions of ¼-pixel accuracy pixels. In the following description, Clip( ) is defined first as follows.

$$\begin{matrix}[ Math . 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that when an input image is an image with 8-bit accuracy, the value of max_pix is 255.

The pixel values at the positions b and d are generated using a 6-tap FIR filter as follows:

[Math. 2]

F=A₋₂−5·A₋₁+20·A₀+20·A₁−5·A₂+A₃

b, d=Clip1((F+16)>>5) (2)

The pixel value at the position c is generated using a 6-tap FIR filter in the horizontal direction and the vertical direction as follows:

[Math. 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

Note that after a product-sum operation in the horizontal direction and a product-sum operation in the vertical direction are performed, the Clip process is finally performed only once.

The positions e1 to e3 are generated using linear interpolation as follows:

[Math. 4]

e₁=(A+b+1)>>1

e₂=(b+d+1)>>1

e₃=(b+c+1)>>1 (4)

Referring back to FIG. 1, the A/D conversion unit 61 A/D-converts an input image and outputs the converted image into the re-ordering screen buffer 62, which stores the converted image. Thereafter, the re-ordering screen buffer 62 re-orders, in accordance with the GOP (Group of Picture), the images of frames arranged in the order in which they are stored so that the images are arranged in the order in which the frames are to be encoded.

The computing unit 63 subtracts, from the image read from the re-ordering screen buffer 62, a predicted image that is received from the intra prediction unit 74 and that is selected by the predicted image selecting unit 78 or a predicted image that is received from the motion prediction/compensation unit 73. Thereafter, the computing unit 63 outputs the difference information to the orthogonal transform unit 64. The orthogonal transform unit 64 performs orthogonal transform, such as discrete cosine transform or Karhunen-Loeve transform, on the difference information received from the computing unit 63 and outputs the transform coefficient. The quantizer unit 65 quantizes the transform coefficient output from the orthogonal transform unit 64.

The quantized transform coefficient output from the quantizer unit 65 is input to the lossless encoding unit 66. The lossless encoding unit 66 performs lossless encoding, such as variable-length encoding or arithmetic coding. Thus, the quantized transform coefficient is compressed.

The lossless encoding unit 66 acquires information regarding intra prediction from the intra prediction unit 74 and acquires information regarding inter prediction and inter-template prediction from the motion prediction/compensation unit 73. The lossless encoding unit 66 encodes the quantized transform coefficient. In addition, the lossless encoding unit 66 encodes the information regarding intra prediction and the information regarding inter prediction and inter-template prediction. The encoded information serves as part of header information. The lossless encoding unit 66 supplies the encoded data to the accumulation buffer 67, which accumulates the encoded data.

For example, in the lossless encoding unit 66, a lossless encoding process, such variable-length coding (e.g., CAVLC (Context-Adaptive Variable Length Coding) defined by the H.264/AVC standard) or an arithmetic coding (e.g., CABAC (Context-Adaptive Binary Arithmetic Coding)), is performed. The CABAC encoding method is described below.

The accumulation buffer 67 outputs, to, for example, a downstream recording apparatus or a downstream transmission line (neither is shown), the data supplied from the lossless encoding unit 66 in the form of a compressed image encoded using the H.264/AVC standard.

In addition, the quantized transform coefficient output from the quantizer unit 65 is also input to the inverse quantizer unit 68 and is inverse-quantized. Thereafter, the transform coefficient is further subjected to inverse orthogonal transformation in the inverse orthogonal transducer unit 69. The result of the inverse orthogonal transformation is added to the predicted image supplied from the predicted image selecting unit 78 by the computing unit 70. In this way, a locally decoded image is generated. The de-blocking filter 71 removes block distortion of the decoded image and supplies the decoded image to the frame memory 72. Thus, the decoded image is accumulated. In addition, the image before the de-blocking filter process is performed by the de-blocking filter 71 is also supplied to the frame memory 72 and is accumulated.

The switch 73 outputs the reference image accumulated in the frame memory 72 to the motion prediction/compensation unit 75 or the intra prediction unit 74.

In the image encoding apparatus 51, for example, an I picture, a B picture, and a P picture received from the re-ordering screen buffer 62 are supplied to the intra prediction unit 74 as images to be subjected to intra prediction (also referred to as an “intra process”). In addition, a B picture and a P picture read from the re-ordering screen buffer 62 are supplied to the motion prediction/compensation unit 73 as images to be subjected to inter prediction (also referred to as an “inter process”).

The intra prediction unit 74 performs an intra prediction process in all of the candidate intra prediction modes using the image to be subjected to intra prediction and read from the re-ordering screen buffer 62 and the reference image supplied from the frame memory 72. Thus, the intra prediction unit 74 generates a predicted image.

At that time, the intra prediction unit 74 computes a cost function value for each of the candidate intra prediction modes and selects the intra prediction mode that minimizes the computed cost function value as an optimal intra prediction mode.

The intra prediction unit 74 supplies the predicted image generated in the optimal intra prediction mode and the cost function value of the optimal intra prediction mode to the predicted image selecting unit 78. When the predicted image generated in the optimal intra prediction mode is selected by the predicted image selecting unit 78, the intra prediction unit 74 supplies information regarding the optimal intra prediction mode to the lossless encoding unit 66. The lossless encoding unit 66 encodes the information and uses the information as part of the header information.

The motion prediction/compensation unit 75 performs a motion prediction/compensation process for each of the candidate inter prediction modes. That is, the motion prediction/compensation unit 75 detects a motion vector in each of the candidate inter prediction modes on the basis of the image to be subjected to inter process and read from the re-ordering screen buffer 62 and the reference image supplied from the frame memory 72 via the switch 73. Thereafter, the motion prediction/compensation unit 75 performs motion prediction/compensation on the reference image on the basis of the motion vectors and generates a predicted image.

In addition, the motion prediction/compensation unit 75 supplies, to the template motion prediction/compensation unit 76, the image to be subjected to inter process and read from the re-ordering screen buffer 62 and the reference image supplied from the frame memory 72 via the switch 73.

Furthermore, the motion prediction/compensation unit 75 computes a cost function value for each of the candidate inter prediction modes. The motion prediction/compensation unit 75 selects, as an optimal inter Prediction mode, the prediction mode that minimizes the cost function value from among the cost function values computed for the inter prediction modes and the cost function values computed for the inter-template prediction modes by the template motion prediction/compensation unit 76.

The motion prediction/compensation unit 75 supplies the predicted image generated in the optimal inter prediction mode and the cost function value of the predicted image to the predicted image selecting unit 78. When the predicted image generated by the predicted image selecting unit 78 in the optimal inter prediction mode is selected, the motion prediction/compensation unit 75 supplies, to the lossless encoding unit 66, information regarding the optimal inter prediction mode and information associated with the optimal inter prediction mode (e.g., the motion vector information, the flag information, and the reference frame information). The lossless encoding unit 66 also performs a lossless encoding process, such as variable-length encoding or an arithmetic coding, on the information received from the motion prediction/compensation unit 75 and inserts the information into the header portion of the compressed image.

The template motion prediction/compensation unit 76 performs a motion prediction and compensation process on the basis of the image supplied from the re-ordering screen buffer 62 and to be inter processed and a reference image supplied from the frame memory 72 and generated a predicted image.

The template motion prediction/compensation unit 76 performs the motion prediction and compensation process on a block included in a P slice or a B slice. For the B slice, the template motion prediction/compensation unit 76 performs the motion prediction and compensation process on both reference frames List0 and List1. Note that hereinafter, List0 and List1 are also referred to as “L0” and “L1”, respectively.

At that time, for the L0 reference frame, the template motion prediction/compensation unit 76 performs a motion search in an inter-template prediction mode within a predetermined area. Thereafter, the template motion prediction/compensation unit 75 performs a compensation process and generates a predicted image. In contrast, for the L1 reference frame, the template motion prediction/compensation unit 76 performs a motion search in an inter-template prediction mode within a predetermined area around a search center computed by the L1 search center computing unit 77. Thereafter, the template motion prediction/compensation unit 76 performs a compensation process and generates a predicted image.

Accordingly, upon performing a motion search for an L1 reference frame, the template motion prediction/compensation unit 76 supplies the image read from the re-ordering screen buffer 62 and to be inter encoded and the reference image supplied from the frame memory 72 to the L1 -search center computing unit 77. Note that at that time, the Motion vector information searched for on the L0 reference frame is also supplied to the L1 search center computing unit 77.

In addition, the template motion prediction/compensation unit 76 considers the mean value of the predicted images generated for the L0 and L1 reference frames as a predicted image and computes the cost function value for the inter-template prediction mode. Thereafter, the template motion prediction/compensation unit 76 supplies the computed cost function value and the predicted image to the motion prediction/compensation unit 75.

The L1 search center computing unit 77 operates only when the block to be processed is included in the B slice. The L1 search center computing unit 77 computes the search center of the motion vector for the L1 reference frame using the motion vector information searched for on the L0 reference frame. More specifically, the L1 search center computing unit 77 computes the motion vector search center in the L1 reference frame by scaling, on a time axis, the motion vector information searched for on the L0 reference frame using a distance to a target frame to be encoded next.

The predicted image selecting unit 78 determines an optimal prediction mode from among the optimal intra prediction mode and the optimal inter prediction mode on the basis of the cost function values output from the intra prediction unit 74 or the motion prediction/compensation unit 75. Thereafter, the predicted image selecting unit 78 selects the predicted image in the determined optimal prediction mode and supplies the selected predicted image to the computing units 63 and 70. At that time, the predicted image selecting unit 78 supplies selection information regarding the predicted image to the intra prediction unit 74 or the motion prediction/compensation unit 75.

The rate control unit 79 controls the rate of the quantization operation performed by the quantizer unit 65 on the basis of the compressed images accumulated in the accumulation buffer 67 so that overflow and underfloor does not occur.

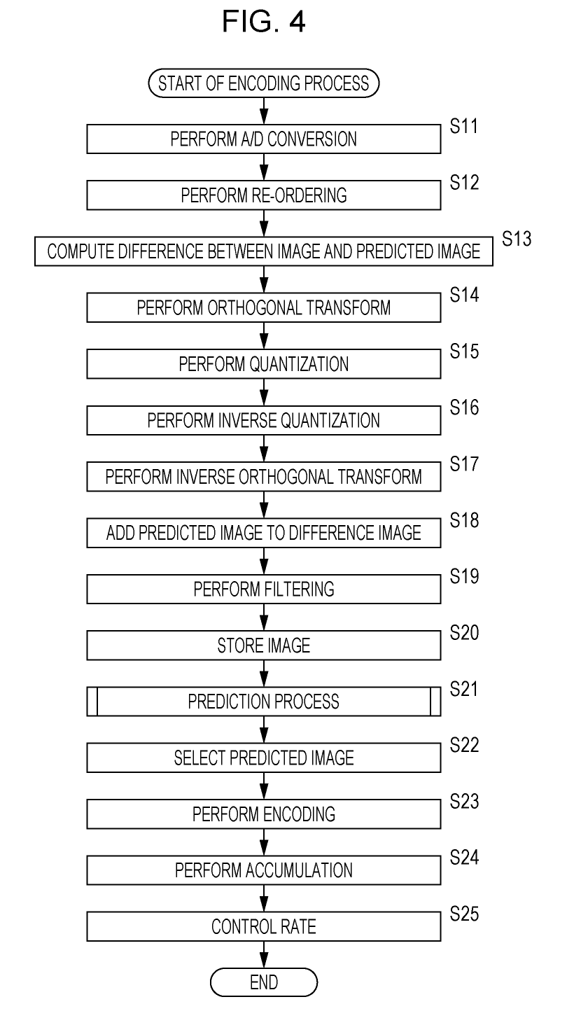

The encoding process performed by the image encoding apparatus 51 shown in FIG. 1 is described next with reference to a flowchart shown in FIG. 4.

In step S11, the A/D conversion unit 61 A/D-converts an input image. In step S12, the re-ordering screen buffer 62 stores the images supplied from the A/D conversion unit 61 and converts the order in which pictures are displayed into the order in which the pictures are to be encoded.

In step S13, the computing unit 63 computes the difference between the image re-ordered in step S12 and the predicted image. The predicted image is supplied from the motion prediction/compensation unit 75 in the case of inter prediction and is supplied from the intra prediction unit 74 in the case of intra prediction to the computing unit 63 via the predicted image selecting unit 78.

The data size of the difference data is smaller than that of the original image data. Accordingly, the data size can be reduced, as compared with the case in which the image is directly encoded.

In step S14, the orthogonal transform unit 64 performs orthogonal transform on the difference information supplied from the computing unit 63. More specifically, orthogonal transform, such as discrete cosine transform or Karhunen-Loeve transform, is performed, and a transform coefficient is output. In step S15, the quantizer unit 65 quantizes the transform coefficient. As described in more detail below with reference to a process performed in step S25, the rate is controlled in this quantization process.

The difference information quantized in the above-described manner is locally decoded as follows. That is, in step S16, the inverse quantizer unit 68 inverse quantizes the transform coefficient quantized by the quantizer unit 65 using a characteristic that is the reverse of the characteristic of the quantizer unit 65. In step S17, the inverse orthogonal transform unit 69 performs inverse orthogonal transform on the transform coefficient inverse quantized by the inverse quantizer unit 68 using the characteristic corresponding to the characteristic of the orthogonal transform unit 64.

In step S18, the computing unit 70 adds the predicted image input via the predicted image selecting unit 78 to the locally decoded difference image. Thus, the computing unit 70 generates a locally decoded image (an image corresponding to the input of the computing unit 63). In step S19, the de-blocking filter 71 performs filtering on the image output from the computing unit 70. In this way, block distortion is removed. In step S20, the frame memory 72 stores the filtered image. Note that the image that is not subjected to the filtering process performed by the de-blocking filter 71 is also supplied to the frame memory 72 and is stored in the frame memory 72.

In step S21, each of the intra prediction unit 74, the motion prediction/compensation unit 75, and the template motion prediction/compensation unit 76 performs its own image prediction process. That is, in step S21, the intra prediction unit 74 performs an intra-prediction process in the intra prediction mode. The motion prediction/compensation unit 75 performs a motion prediction/compensation process in the inter prediction mode. In addition, the template motion prediction/compensation unit 76 performs a motion prediction/compensation process in the inter-template prediction mode.

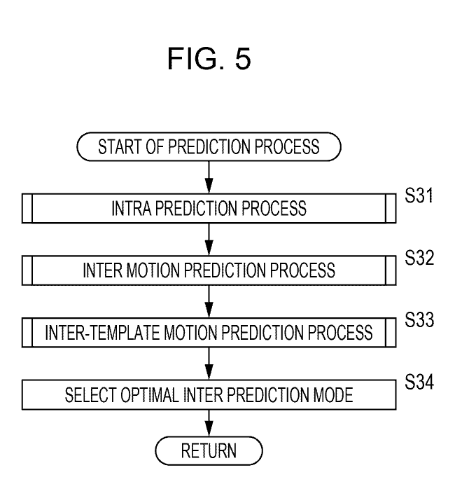

The prediction process performed in step S21 is described in more detail below with reference to FIG. 5. Through the prediction process performed in step S21, the prediction process in each of the candidate prediction modes is performed, and the cost function values for all of the candidate prediction modes are computed. Thereafter, the optimal intra prediction mode is selected on the basis of the computed cost function values, and a predicted image generated using intra prediction in the optimal intra prediction mode and the cost function value of the predicted image are supplied to the predicted image selecting unit 78. In addition, the optimal inter prediction mode is determined from among the inter prediction modes and the inter-template prediction modes using the computed cost function values. Thereafter, a predicted image generated in the optimal inter prediction mode and the cost function value of the predicted image are supplied to the predicted image selecting unit 78.

In step S22, the predicted image selecting unit 78 selects one of the optimal intra prediction mode and the optimal inter prediction mode as an optimal prediction mode using the cost function values output from the intra prediction unit 74 and the motion prediction/compensation unit 75. Thereafter, the predicted image selecting unit 78 selects the predicted image in the determined optimal prediction mode and supplies the predicted image to the computing units 63 and 70. As described above, this predicted image is used for the computation performed in steps S13 and S18.

Note that the selection information regarding the predicted image is supplied to the intra prediction unit 74 or the motion prediction/compensation unit 75. When the predicted image in the optimal intra prediction mode is selected, the intra prediction unit 74 supplies information regarding the optimal intra prediction mode (i.e., the intra prediction mode information) to the lossless encoding unit 66.

When the predicted image in the optimal inter prediction mode is selected, the motion prediction/compensation unit 73 supplies information regarding the optimal inter prediction mode and information associated with the optimal inter prediction mode (e.g., the motion vector information, the flag information, and the reference frame information) to the lossless encoding unit 66. More specifically, when the predicted image in the inter prediction mode is selected as the optimal inter prediction mode, the motion prediction/compensation unit 75 outputs the inter prediction mode information, the motion vector information, and the reference frame information to the lossless encoding unit 66.

In contrast, when the predicted image in the inter-template prediction mode is selected as the optimal inter prediction mode, the motion prediction/compensation unit 75 supplies the inter-template prediction mode information, the motion vector information, and the sub-pixel-based motion vector information to the lossless encoding unit 66. That is, since transfer of the motion vector information to the decoding side is not needed, the motion vector information is not output to the lossless encoding unit 66. Accordingly, the motion vector information in the compressed image can be reduced.

In step S23, the lossless encoding unit 66 encodes the quantized transform coefficient output from the quantizer unit 65. That is, the difference image is lossless encoded (e.g., variable-length encoded or arithmetic encoded) and is compressed. At that time, the above-described intra prediction mode information input from the intra prediction unit 74 to the lossless encoding unit 66 or the above-described information associated with the optimal inter prediction mode (e.g., the prediction mode information, the motion vector information, and the reference frame information) input from the motion prediction/compensation unit 75 to the lossless encoding unit 66 in step S22 is also encoded and is added to the header information.

In step S24, the accumulation buffer 67 accumulates the difference image as a compressed image. The compressed image accumulated in the accumulation buffer 67 is read as needed and is transferred to the decoding side via a transmission line.

In step S25, the rate control unit 79 controls the rate of the quantization operation performed by the quantizer unit 65 on the basis of the compressed images stored in the accumulation buffer 67 so that overflow and underflow do not occur.

The prediction process performed in step S21 shown in FIG. 4 is described next with reference to a flowchart shown in FIG. 5.

If each of the images supplied from the re-ordering screen buffer 62 and to be processed is an image of a block to be intra processed, the decoded image to be referenced is read from the frame memory 72 and is supplied to the intra prediction unit 74 via the switch 73. In step S31, the intra prediction unit 74 performs, using the images, intra prediction on a pixel of the block to be processed in all of the candidate intra prediction modes. Note that the pixel that is not subjected to deblock filtering performed by the de-blocking filter 71 is used as the decoded pixel to be referenced.

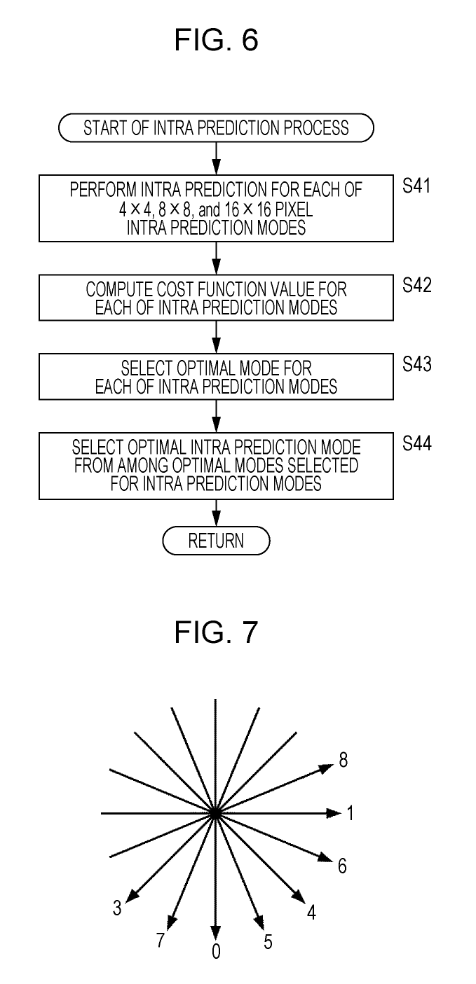

The intra-prediction process performed in step S31 is described below with reference to FIG. 6. Through the intra-prediction process, intra prediction is performed in all of the candidate intra prediction modes, and the cost function values for all of the candidate intra prediction modes are computed. Thereafter, an optimal intra prediction mode is selected on the basis of the computed cost function values. A predicted image generated through intra prediction in the optimal intra prediction mode and the cost function value thereof are supplied to the predicted image selecting unit 78.

If each of the images supplied from the re-ordering screen buffer 62 and to be processed is an image to be subjected to the inter process, an image to be referenced is read from the frame memory 72 and is supplied to the motion prediction/compensation unit 75 via the switch 73. In step S32, the motion prediction/compensation unit 75 performs, using the images, an inter motion prediction process. That is, the motion prediction/compensation unit 75 references the images supplied from the frame memory 72 and performs a motion prediction process in all of the candidate inter prediction modes.

The inter motion prediction process performed in step S32 is described in more detail below with reference to FIG. 9. Through the inter motion prediction process, a motion prediction process is performed in all of the candidate inter prediction modes, and cost function values for all of the candidate inter prediction modes are computed.

In addition, if each of the images supplied from the re-ordering screen buffer 62 and to be processed is an image to be subjected to the inter process, an image to be referenced is read from the frame memory 72 and is also supplied to the template motion prediction/compensation unit 76 via the switch 73 and the motion prediction/compensation unit 75. In step S33, the template motion prediction/compensation unit 76 performs an inter-template motion prediction process using the images.

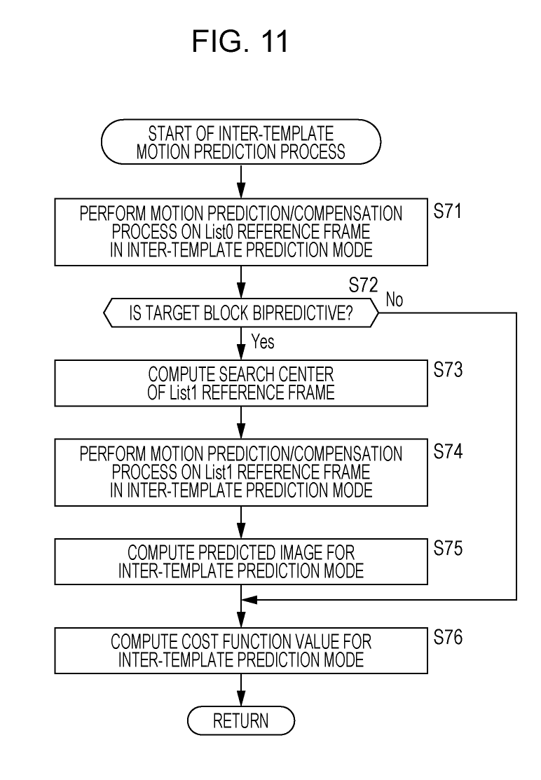

The inter-template motion prediction process performed in step S33 is described in more detail below with reference to FIG. 11. Through the inter-template motion prediction process, a motion prediction process is performed in the inter-template prediction mode, and a cost function value for the inter-template prediction mode is computed. Thereafter, the predicted image generated through the motion prediction process in the inter-template prediction mode and the cost function value thereof are supplied to the motion prediction/compensation unit 75. Note that if information associated with the inter-template prediction mode (e.g., prediction mode information) is present, such information is also supplied to the motion prediction/compensation unit 75.

In step S34, the Motion prediction/compensation unit 75 compares the cost function value for the inter prediction mode computed in step S32 with the cost function value for the inter-template prediction mode computed in step S33. Thus, the prediction mode that provides the minimum cost function value is selected as an optimal inter prediction mode. Thereafter, the motion prediction/compensation unit 75 supplies a predicted image generated in the optimal inter prediction mode and the cost function value thereof to the predicted image selecting unit 78.

The intra prediction process performed in step S31 shown in FIG. 5 is described next with reference to a flowchart shown in FIG. 6. Note that an example illustrated in FIG. 6 is described with reference to a luminance signal.

In step S41, the intra prediction unit 74 performs intra prediction for 4×4 pixels, 8×8 pixels, and 16×16 pixels in the intra prediction mode.

The intra prediction mode of a luminance signal includes prediction modes based on 9 types of 4×4 pixel blocks and 8×8 pixel blocks and 4 types of 16×16 pixel macroblocks. In contrast, the intra prediction mode of a color difference signal includes prediction modes based on 4 types of 8×8 pixel blocks. The intra prediction mode of a color difference signal can be set independently from the intra prediction mode of a luminance signal. For the 4×4 pixel and 8×8 pixel intra prediction modes of a luminance signal, an intra prediction mode can be defined for each of the 4×4 pixel and 8×8 pixel blocks of a luminance signal. For the 16×16 pixel intra prediction mode of a luminance signal and the intra prediction mode of a color difference signal; an intra prediction mode can be defined for one macroblock.

The types of the prediction mode correspond to the directions indicated by the numbers “0”, “1”, and “3” to “8” shown in FIG. 7. The prediction mode “2” represents a mean prediction.

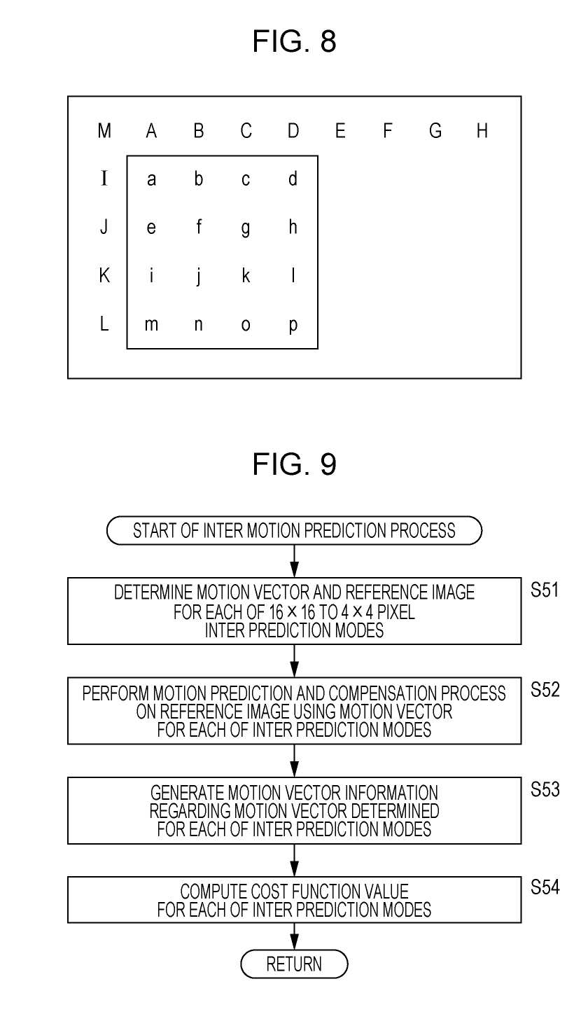

For example, the intra 4×4 prediction mode is described with reference to FIG. 8. When an image to be processed and read from the re-ordering screen buffer 62 (e.g., pixels a to p) is the image of a block to be intra processed, a decoded image to be referenced (pixels A to M) is read from the frame memory 72. Thereafter, the readout image is supplied to the intra prediction unit 74 via the switch 73.

The intra prediction unit 74 performs intra prediction on the pixels of the block to be processed using these images. Such an intra-prediction process is performed for each of the intra prediction modes and, therefore, a predicted image for each of the intra prediction modes is generated. Note that pixels that are not subjected to deblock filtering performed by the de-blocking filter 71 are used as the decoded pixels to be referenced (the pixels A to M).

In step S42, the intra prediction unit 74 computes the cost function values for each of 4×4 pixel, 8×8 pixel, and 16×16 pixel intra prediction modes. At that time, the computation of the cost function values is performed using one of the methods of a High Complexity mode and a Low Complexity mode as defined in the JM (Joint Model), which is H.264/AVC reference software.

That is, in the High Complexity mode, the processes up to the encoding process are performed for all of the candidate prediction modes as a process performed in step S41. Thus, a cost function value defined by the following equation (5) is computed for each of the prediction modes and, thereafter, the prediction mode that provides a minimum cost function value is selected as an optimal prediction mode.

Cost(Mode)=D+λ·R (5)

where D denotes the difference (distortion) between the original image and the decoded image, R denotes an amount of generated code including up to the orthogonal transform coefficient, and λ denotes the Lagrange multiplier in the form of a function of a quantization parameter QP.

In contrast, in the Low Complexity mode, generation of a predicted image and computation of the motion vector information, prediction mode information, and the header bit of the flag information are performed for all of the candidate prediction modes as a process performed in step S41. Thus, the cost function value expressed in the following equation (6) is computed for each of the prediction modes and, thereafter, the prediction mode that provides a minimum cost function value is selected as an optimal prediction mode.

Cost(Mode)=D+QPtoQuant(QP)·Header_Bit (6)

where D denotes the difference (distortion) between the original image and the decoded image, Header_Bit denotes a header bit for the prediction mode, and QPtoQuant denotes a function provided in the form of a function of a quantization parameter QP.

In the Low Complexity mode, only a predicted image is generated for each of the prediction mode. An encoding process and a decoding process need not be performed. Accordingly, the amount of computation can be reduced.

In step S43, the intra prediction unit 74 determines an optimal mode for each of the 4×4 pixel, 8×8 pixel, and 16×16 pixel intra prediction modes. That is, as described above with reference to FIG. 7, in the case of the 4×4 pixel and 8×8 pixel intra prediction modes, there are nine types of prediction mode. In the case of the 16×16 pixel intra prediction mode, there are four types of prediction modes. Accordingly, from among these prediction modes, the intra prediction unit 74 selects the optimal 4×4 pixel intra prediction mode, the optimal 8×8 pixel intra prediction mode, and the optimal 16×16 pixel intra prediction mode on the basis of the cost function values computed in step S42.

In step S44, from among the optimal modes selected for the 4×4 pixel, 8×8 pixel, and the 16×16 pixel intra prediction modes, the intra prediction unit 74 selects the optimal intra prediction mode on the basis of the cost function values computed in step S42. That is, from among the optimal modes selected for the 4×4 pixel, 8×8 pixel, and the 16×16 pixel intra prediction modes, the intra prediction unit 74 selects the mode having the minimum cost function value as the optimal intra prediction mode. Thereafter, the intra prediction unit 74 supplies the predicted image generated in the optimal intra prediction mode and the cost function value thereof to the predicted image selecting unit 78.

The inter motion prediction process performed in step S32 shown in FIG. 5 is described next with reference to a flowchart shown in FIG. 9.

In step S51, the motion prediction/compensation unit 75 determines the motion vector and the reference image for each of the eight 16×16 pixel to 4×4 pixel inter prediction modes illustrated in FIG. 2. That is, the motion vector and the reference image are determined for a block to be processed for each of the inter prediction modes.

In step S52, the motion prediction/compensation unit 75 performs a motion prediction and compensation process on the reference image for each of the eight 16×16 pixel to 4×4 pixel inter prediction modes on the basis of the motion vector determined in step S51. Through the motion prediction and compensation process, a predicted image is generated for each of the inter prediction modes.

In step S53, the motion prediction/compensation unit 75 generates motion vector information to be added to the compression image for the motion vector determined for each of the eight 16×16 pixel to 4×4 pixel inter prediction modes.

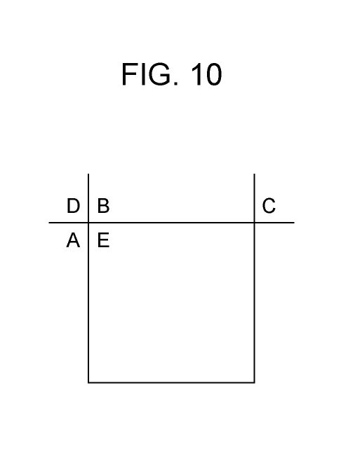

A method for generating the motion vector information in the H.264/AVC standard is described next with reference to FIG. 10. In the example shown in FIG. 10, a target block E to be encoded next (e.g., 16×16 pixels) and blocks A to D that have already been encoded and that are adjacent to the target block E are shown.

That is, the block D is adjacent to the upper left corner of the target block E. The block B is adjacent to the upper end of the target block E. The block C is adjacent to the upper right corner of the target block E. The block A is adjacent to the left end of the target block E. Note that the entirety of each of the blocks A to D is not shown, since the blocks A to D is one of 16×16 pixel to 4×4 pixel blocks illustrated in FIG. 2.

For example, let mvₓ denote motion vector information for X (=A, B, C, D, E). Prediction motion vector information pmv_{E} for the target block E is expressed using the motion vector information for the blocks A, B, and C and median prediction as follows.

pmv_{E}=med(mv_{A}, mv_{B}, mv_{C}) (7)

If the motion vector information regarding the block C is unavailable because, for example, the block C is located at the end of the image frame or the block C has not yet been encoded, the motion vector information regarding the block D is used in stead of the motion vector information regarding the block C.

Data mvd_{E} to be added to the header portion of the compressed image as the motion vector information regarding the target block E is given using pmv_{E} as follows:

mvd_{E}=mv_{E}−pmv_{E} (8)

Note that in practice, the process is independently performed for a horizontal-direction component and a vertical-direction component, of the motion vector information.

In this way, the prediction motion vector information is generated, and a difference between the prediction motion vector information generated using a correlation between neighboring blocks and the motion vector information is added to the header portion of the compressed image. Thus, the motion vector information can be reduced.

The motion vector information generated in the above-described manner is also used for computation of the cost function value performed in the subsequent step S54. If the predicted image corresponding to the motion vector information is finally selected by the predicted image selecting unit 78, the motion vector information is output to the lossless encoding unit 66 together with the prediction mode information and the reference frame information.

Referring back to FIG. 9, in step S54, the motion prediction/compensation unit 75 computes the cost function value for each of the eight 16×16 pixel to 4×4 pixel inter prediction modes using equation (5) or (6). The computed cost function values here are used for selecting the optimal inter prediction mode in step S34 shown in FIG. 5 as described above.

The inter-template motion prediction process performed in step S33 shown in FIG. 5 is described with reference to a flowchart shown in FIG. 11.

In step S71, the template motion prediction/compensation unit 76 performs a motion prediction/compensation process in the inter-template prediction mode for the List0 reference frame. That is, the template motion prediction/compensation unit 76 searches for a motion vector for the List0 reference frame using an inter-template matching method. Thereafter, the template motion prediction/compensation unit 76 performs a motion prediction/compensation process on the reference image on the basis of the searched motion vector. In this way, the template motion prediction/compensation unit 76 generates a predicted image.

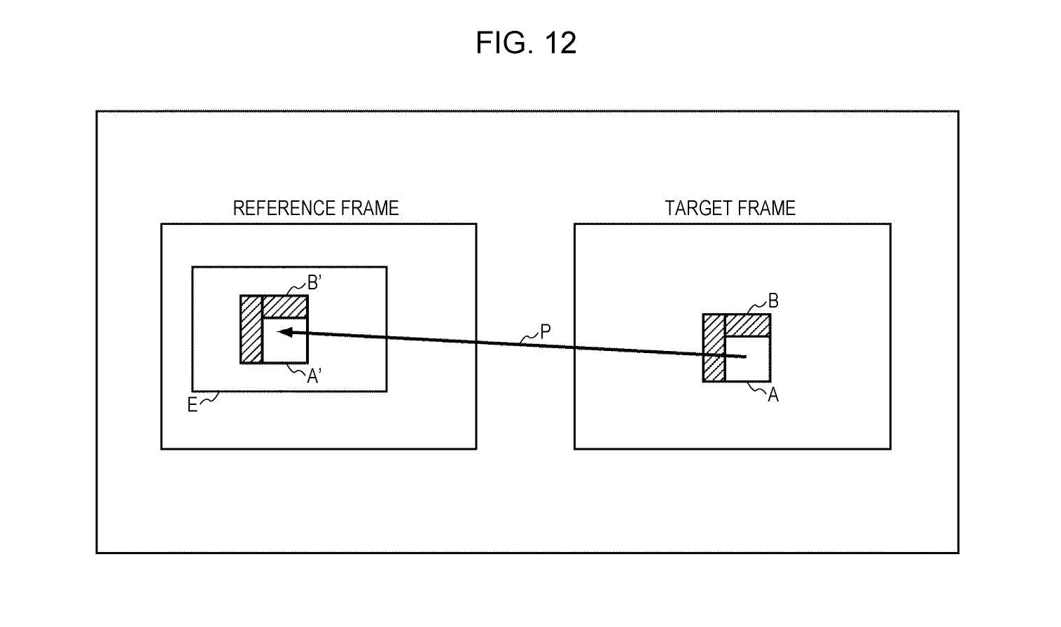

The inter-template matching method is described in more detail with reference to FIG. 12.

In the example shown in FIG. 12, a target frame to be encoded and a reference frame referenced when a motion vector is searched for are shown. In the target frame, a target block A to be encoded next and a template region B including pixels that are adjacent to the target block A and that have already been encoded are shown. That is, as shown in FIG. 12, when an encoding process is performed in the raster scan order, the template region B is located on the left of the target block A and on the upper side of the target block A. In addition, the decoded image of the template region B is accumulated in the frame memory 72.

The template motion prediction/compensation unit 76 performs a template matching process in a predetermined search area E in the reference frame using, for example, SAD (Sum of Absolute Difference) as a cost function value. The template motion prediction/compensation unit 76 searches for a region B′ having the highest correlation with the pixel values of the template region B. Thereafter, the template motion prediction/compensation unit 76 considers a block A′ corresponding to the searched region B′ as a predicted image for the target block A and searches for a motion vector P for the target block A.

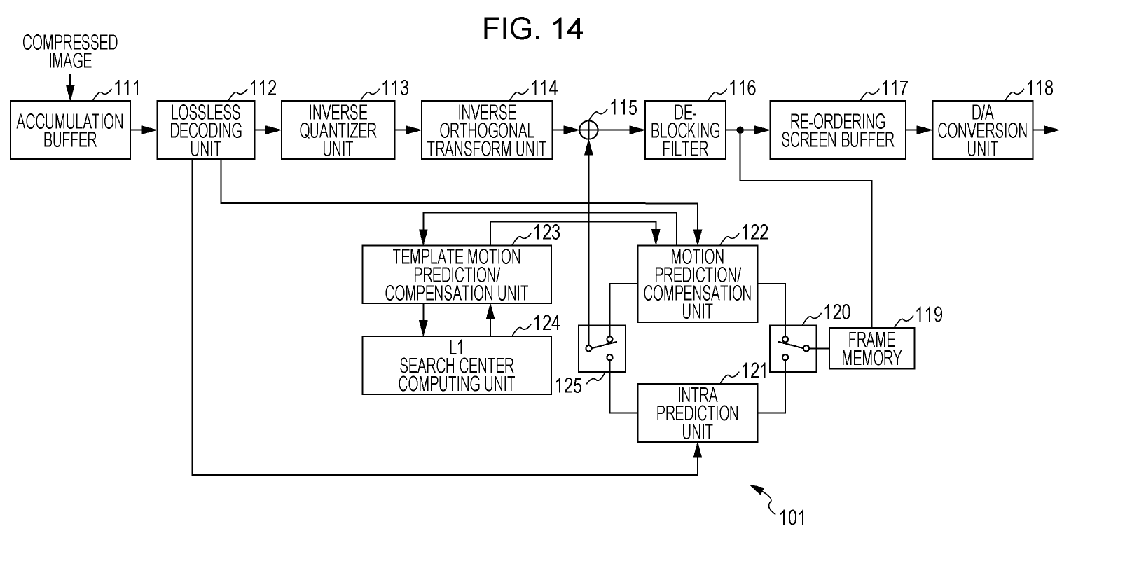

In this way, in the motion vector search process using the inter-template matching method, a decoded image is used for the template matching process. Accordingly, by predefining the predetermined search area E, the same process can be performed in the image encoding apparatus 51 shown in FIG. 1 and an image decoding apparatus 101 shown in FIG. 14 (described below). That is, by providing a template motion prediction/compensation unit 123 in the image decoding apparatus 101 as well, information regarding the motion vector P for the target block A need not be sent to the image decoding apparatus 101. Therefore, the motion vector information in a compressed image can be reduced.

Note that any sizes of a block and a template can be employed in the inter-template prediction mode. That is, as in the motion prediction/compensation unit 75, from among the eight 16×16 pixel to 4×4 pixel block sizes illustrated in FIG. 2, one block size may be selected, and the process may be performed using the block size at all times. Alternatively, the process may be performed using all the block sizes as candidates. The template size may be changed in accordance with the block size or may be fixed to one size.

Referring back to FIG. 11, in step S72, the template motion prediction/compensation unit 76 determines whether the target block currently encoded is bipredictive. If, in step S72, it is determined that the target block is bipredictive, the template motion prediction/compensation unit 76, in step S73, instructs the L1 search center computing unit 77 to compute the search center in the L1 reference frame. Thereafter, in step S74, the template motion prediction/compensation unit 76 performs a motion search in a predetermined area around the search center computed by the L1 search center' computing unit 77 in the L1 reference frame. Thus, the template motion prediction/compensation unit 76 performs a compensation process and generates a predicted image.

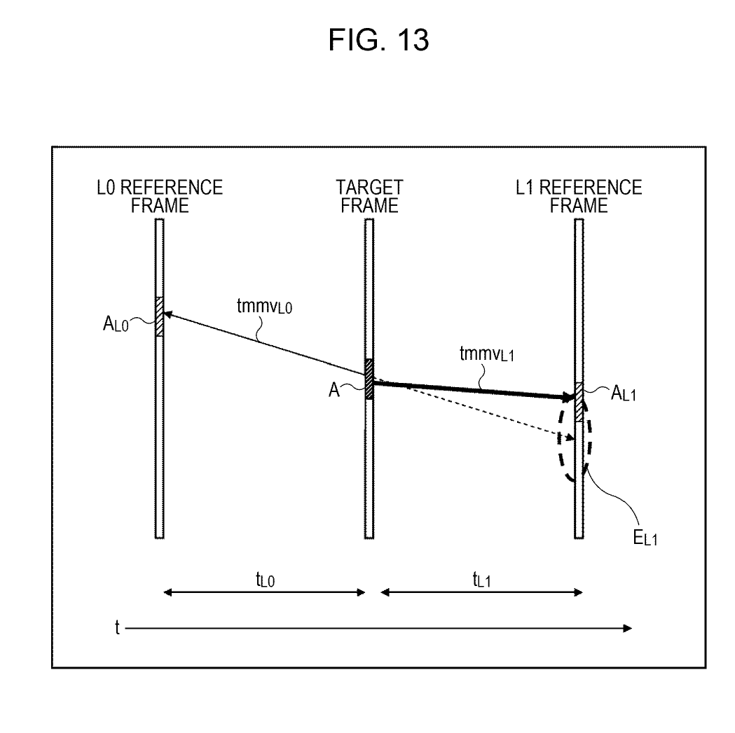

The above-described processes performed in steps S71 to S74 are described in more detail with reference to FIG. 13. In the example shown in FIG. 13, a time axis t represents the elapse of time. From the left, an L0 (List0) reference frame, a target frame to be encoded next, and an L1 (List1) reference frame are shown. A target block A of a target frame is included in a B slice. Motion prediction/compensation is performed for the L0 reference frame and the L1 reference frame.

Firstly, in step S71, the template motion prediction/compensation unit 76 performs a motion prediction/compensation process in the inter-template prediction mode between the target block A included in the B slice and the L0 reference frame.

Through the process performed in step S71, firstly, an area B_{L0} having the highest correlation with the pixel values of a template area B including already encoded pixels is searched for within a predetermined search area in the L0 reference frame. As a result, a motion vector tmmv_{L0} of the target block A is searched for using a block A_{L0} corresponding to the searched area B_{L0} as a predicted image of the target block A.

Subsequently, in step S72, it is determined whether the currently encoded target block is bipredictive. If, in step S72, it is determined that the currently encoded target block is bipredictive, the processing proceeds to step S73. The L1 search center computing unit 77 operates only when the currently encoded target block is bipredictive, that is, only when the target block is included in the B slice.

In step S73, the L1 search center computing unit 77 computes the motion search center of the L1 reference frame using the motion vector tmmv_{L0} searched for in the L0 reference frame, a distance t_{L0} between the target frame and the L0 reference frame on the time axis t and a distance t_{L1} between the target frame and the L1 reference frame on the time axis t.

Through the process performed in step S73, as indicated by a dotted arrow shown in FIG. 13, the motion vector tmmv_{L0} searched for in the L0 reference frame is extended (scaled) towards the L1 reference frame in accordance with the distance t_{L0} between the target frame and the L0 reference frame on the time axis t and the distance t_{L1} between the target frame and the L1 reference frame on the time axis t. Thus, the search center of the L1 reference frame is computed. Note that in practice, information regarding the motion vector extended towards the L1 side is rounded to information with integer-pixel accuracy and is used as the search center of the L1 reference frame.

That is, the search center is computed using the following expression (9).

$$\begin{matrix}[ math . 5 ] & \\ ( - \frac{{t}_{L 1}}{{t}_{L 0}} \cdot {tmmv}_{L 0 \_ h} , - \frac{{t}_{L 1}}{{t}_{L 0}} \cdot {tmmv}_{L 0 \_ v} ) & ( 9 )\end{matrix}$$

Note that expression (9) requires division. However, in practice, by approximating t_{L1}/t_{L0} to N/2^{M} (M and N are integers) and performing a shift operation including a round-off operation, expression (9) can be computed.

In addition, in the H.264/AVC standard, information items corresponding to the distances t_{L0} and t_{L1} on the time axis t for the target frame are not included in a compressed image. Accordingly, the POC (Picture Order Count) that is information indicating the order in which the pictures are output is used as the values actually representing the distances t_{L0} and t_{L1}.

Note that in the example shown in FIG. 13, the L0 reference frame is forward-predictive while the L1 reference frame is backward-predictive. However, the present invention is not limited to the example shown in FIG. 13. Even in the case in which the L0 reference frame and the L1 reference frame are forward-predictive and in the case in which the L0 reference frame and the L1 reference frame are backward-predictive, a similar operation can be applied. Note that when the L0 reference frame and the L1 reference frame have the same direction, the search center is computed using equation (10) in stead of equation (9).

$$\begin{matrix}[ Math . 6 ] & \\ ( - \frac{{t}_{L 1}}{{t}_{L 0}} \cdot {tmmv}_{L 0 \_ h} , - \frac{{t}_{L 1}}{{t}_{L 0}} \cdot {tmmv}_{L 0 \_ v} ) & ( 10 )\end{matrix}$$

Thereafter, in step S74, the template motion prediction/compensation unit 75 performs a motion search within a predetermined area E_{L1} including several pixels around the search center of the L1 reference frame computed in step S73. Thus, the template motion prediction/compensation unit 75 performs a compensation process and generates a predicted image.

Through the process performed in step S74, the area B_{L1} having the highest correlation with the pixel values of the template area B that is adjacent to the target block A of the target frame and that includes already encoded pixels is searched for within the predetermined area E_{L1} around the search center of the L1. reference frame. As a result, a motion vector tmmv_{L1} of the target block A is searched for using a block A_{L1} corresponding to the searched area B_{L1} as a predicted image of the target block A.

As described above, the motion search area in the L1 reference frame is limited to,a predetermined area around the search center obtained by scaling the motion vector acquired in the L0 reference frame in accordance with the time distance information between the target frame and the L0 reference frame and between the target frame and the L1 reference frame. Thus, in the L1 reference frame, only several neighboring pixels can be searched for. In this way, the amount of computation can be reduced with a minimized decrease in coding efficiency.

Referring back to FIG. 11, in step S75, the template motion prediction/compensation unit 76 computes a predicted image for the target block in the inter-template mode using the predicted images for the L0 and L1 reference frames computed in step S71 or S74.

For example, the template motion prediction/compensation unit 76 considers the mean value of the predicted images for the L0 and L1 reference frames as a predicted image of the target block in the inter-template mode.

Note that in stead of using the mean value, the predicted image for the target block can be computed using, for example, weight prediction. In such a case, the predicted image of the target block can be computed by multiplying two predicted images Y₀ and Y₁ for the L0 and L1 reference frames by predetermined weight coefficients W0 and W1, respectively, and adding a coefficient D to the resultant value (=W₀Y₀+W₁Y₁+D). Alternatively, the predicted image of the target block can be computed in accordance with the time distance information between the target frame and the L0 reference frame and the time distance information between the target frame and the L1 reference frame.

However, if, in step S72, it is determined that the target block is not bipredictive, the processing proceeds to step S76. That is, in this case, the predicted image of the L0 reference frame is considered as a predicted image of the target block in the inter-template mode.

In step S76, the template motion prediction/compensation unit 76 computes the cost function value for the inter-template prediction mode using the above-described equation (5) or (6). The computed cost function value is supplied to the motion prediction/compensation unit 75 together with the predicted image and is used when, as described above, the optimal inter prediction mode is selected in step S34 shown in FIG. 5.

As described above, upon performing a motion prediction/compensation process on the B slice in the inter-template prediction mode, the image encoding apparatus 51 computes the search center of the L1 reference frame using the motion vector information obtained for the L0 reference frame. Thereafter, the image encoding apparatus 51 performs a motion search using the search center of the L1 reference frame. In this way, the amount of computation can be reduced with a minimized decrease in coding efficiency.

In addition, these processes are carried out by not only the image encoding apparatus 51 but also an image decoding apparatus 101 shown in FIG. 14. Accordingly, for a target block in the inter-template prediction mode, transfer of not only the motion vector information but also the reference frame information is not needed. Thus, the coding efficiency can be improved.

The encoded and compressed image is transferred via a predetermined transmission line and is decoded by an image decoding apparatus. FIG. 14 illustrates the configuration of such an image decoding apparatus according to an embodiment of the present invention.

An image decoding apparatus 101 includes an accumulation buffer 111, a lossless decoding unit 112, an inverse quantizer unit 113, an inverse orthogonal transform unit 114, a computing unit 115, a de-blocking filter 116, a re-ordering screen buffer 117, a D/A conversion unit 118, a frame memory 119, a switch 120, an intra prediction unit 121, a motion prediction/compensation unit 122, a template motion prediction/compensation unit 123, an L1 (List1) search center computing unit 124, and a switch 125.

The accumulation buffer 111 accumulates transmitted compressed images. The lossless decoding unit 112 decodes information encoded by the lossless encoding unit 66 shown in FIG. 1 and supplied from the accumulation buffer 111 using a method corresponding to the encoding method employed by the lossless encoding unit 66. The inverse quantizer unit 113 inverse quantizes an image decoded by the lossless decoding unit 112 using a method corresponding to the quantizing method employed by the quantizer unit 65 shown in FIG. 1. The inverse orthogonal transform unit 114 inverse orthogonal transforms the output of the inverse quantizer unit 113 using a method corresponding to the orthogonal transform method employed by the orthogonal transform unit 64 shown in FIG. 1.

The inverse orthogonal transformed output is added to the predicted image supplied from the switch 125 and is decoded by the computing unit 115. The de-blocking filter 116 removes block distortion of the decoded image and supplies the image to the frame memory 119. Thus, the image is accumulated. At the same time, the image is output to the re-ordering screen buffer 117.

The re-ordering screen buffer 117 re-orders images. That is, the order of frames that has been changed by the re-ordering screen buffer 62 shown in FIG. 1 for encoding is changed back to the original display order. The D/A conversion unit 118 D/A-converts an image supplied from the re-ordering screen buffer 117 and outputs the image to a display (not shown), which displays the image.

The switch 120 reads, from the frame memory 119, an image to be inter processed and an image to be referenced. The switch 120 outputs the images to the motion prediction/compensation unit 122. In addition, the switch 120 reads an image used for intra prediction from the frame memory 119 and supplies the image to the intra prediction unit 121.

The intra prediction unit 121 receives, from the lossless decoding unit 112, information regarding an intra prediction mode obtained by decoding the header information. The intra prediction unit 121 generates a predicted image on the basis of such information and outputs the generated predicted image to the switch 125.

The motion prediction/compensation unit 122 receives information regarding an intra prediction mode obtained by decoding the header information (the prediction mode information, the motion vector information, and the reference frame information) from the lossless decoding unit 112. Upon receiving inter prediction mode information, the motion prediction/compensation unit 122 performs a motion prediction and compensation process on the image on the basis of the motion vector information and the reference frame information and generates a predicted image. In contrast, upon receiving inter-template prediction mode information, the motion prediction/compensation unit 122 supplies, to the template motion prediction/compensation unit 123, the image read from the frame memory 119 and to be inter processed and the reference image. The template motion prediction/compensation unit 123 performs a motion prediction/compensation process in an inter-template prediction mode.

In addition, the motion prediction/compensation unit 122 outputs, to the switch 125, one of the predicted image generated in the inter prediction mode and the predicted image generated in the inter-template prediction mode in accordance with the prediction mode information.

The template motion prediction/compensation unit 123 performs a motion prediction and compensation process in the inter-template prediction mode on the basis of the image read from the frame memory 119 and to be inter processed and the image to be referenced. Thus, the template motion prediction/compensation unit 123 generates a predicted image. Note that the motion prediction/compensation process is substantially the same as that performed by the template motion prediction/compensation unit 76 of the image encoding apparatus 51.

That is, the template motion prediction/compensation unit 123 performs a motion prediction and compensation process on s block included in the P slice or the B slice. For the B slice, the template motion prediction/compensation unit 123 performs the motion prediction and compensation process on both the List0 and List1 reference frames.

At that time, for the L0 reference frame, the template motion prediction/compensation unit 123 performs a motion search in an inter-template prediction mode within a predetermined area and performs a compensation process. Thus, the template motion prediction/compensation unit 123 generates a predicted image. In contrast, for the L1 reference frame, the template motion prediction/compensation unit 123 performs a motion search in an inter-template prediction mode within a predetermined area around a search center computed by the L1 search center computing unit 124. Thereafter, the L1 search center computing unit 124 performs a compensation process and generates a predicted image.

Accordingly, upon performing a motion search for the L1 reference frame, the template motion prediction/compensation unit 123 supplies, to the L1 search center computing unit 124, the image read from the frame memory 119 and to be inter processed and the image to be referenced. Note that at that time, the motion vector information searched for on the L0 reference frame is also supplied to the L1 search center computing unit 124.

In addition, for example, the template motion prediction/compensation unit 123 considers the mean value of the predicted images generated for the L0 and L1 reference frames as a predicted image and supplies the predicted image to the motion prediction/compensation unit 122.

The L1 search center computing unit 124 operates only when the block to be processed is included in the B slice. The L1 search center computing unit 124 computes the search center of the motion vector for the L1 reference frame using the motion vector information searched for on the L0 reference frame. More specifically, the L1 search center computing unit 124 computes the motion vector search center in the L1 reference frame by scaling, on a time axis, the motion vector information searched for on the L0 reference frame using a distance to a target frame to be encoded next. Note that the computing process is substantially the same as that performed by the L1 search center computing unit 77 of the image encoding apparatus 51.

The switch 125 selects one of the predicted image generated by the motion prediction/compensation unit 122 and the predicted image generated by the intra prediction unit 121 and supplies the selected one to the computing unit 115.

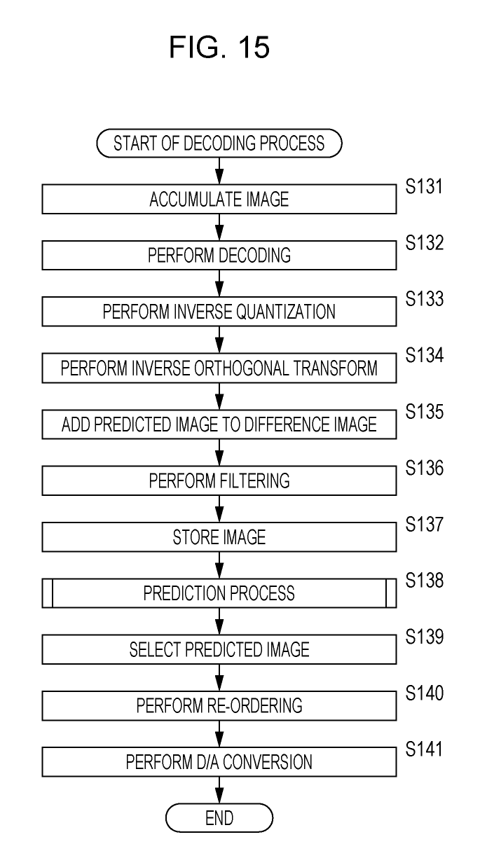

The decoding process performed by the image decoding apparatus 101 is described next with reference to a flowchart shown in FIG. 15.

In step S131, the accumulation buffer 111 accumulates a transferred image. In step S132, the lossless decoding unit 112 decodes a compressed image supplied from the accumulation buffer 111. That is, the I picture, the P picture, and the B picture encoded by the lossless encoding unit 66 shown in FIG. 1 are decoded.

At that time, the motion vector information, the reference frame information, the prediction mode information (information indicating one of an intra prediction mode, an inter prediction mode, and an inter-template prediction mode), and the flag information are also decoded.

That is, if the prediction mode information is intra prediction mode information, the prediction mode information is supplied to the intra prediction unit 121. However, if the prediction mode information is inter prediction mode information, the prediction mode information and the associated motion vector information are supplied to the motion prediction/compensation unit 122. If the prediction mode information is inter-template prediction mode information, the prediction mode information is supplied to the motion prediction/compensation unit 122.

In step S133, the inverse quantizer unit 113 inverse quantizes the transform coefficients decoded by the lossless decoding unit 112 using the characteristics corresponding to the characteristics of the quantizer unit 65 shown in FIG. 1. In step S134, the inverse orthogonal transform unit 114 inverse orthogonal transforms the transform coefficients inverse quantized by the inverse quantizer unit 113 using the characteristics corresponding to the characteristics of the orthogonal transform unit 64 shown in FIG. 1. In this way, the difference information corresponding to the input of the orthogonal transform unit 64 shown in FIG. 1 (the output of the computing unit 63) is decoded.

In step S135, the computing unit 115 adds the predicted image selected in step S141 described below and input via the switch 125 to the difference image. In this way, the original image is decoded. In step S136, the de-blocking filter 116 performs filtering on the image output from the computing unit 115. Thus, block distortion is removed. In step S137, the frame memory 113 stores the filtered image.

In step S138, the intra prediction unit 121, the motion prediction/compensation unit 122, or the template motion prediction/compensation unit 123 performs an image prediction process in accordance with the prediction mode information supplied from the lossless decoding unit 112.

That is, when the intra prediction mode information is supplied from the lossless decoding unit 112, the intra prediction unit 121 performs an intra prediction process in the intra prediction mode. When the inter prediction mode information is supplied from the lossless decoding unit 112, the motion prediction/compensation unit 122 performs a motion prediction/compensation process in the inter prediction mode. However, when the inter-template prediction mode information is supplied from the lossless decoding unit 112, the template motion prediction/compensation unit 123 performs a motion prediction/compensation process in the inter-template prediction mode.

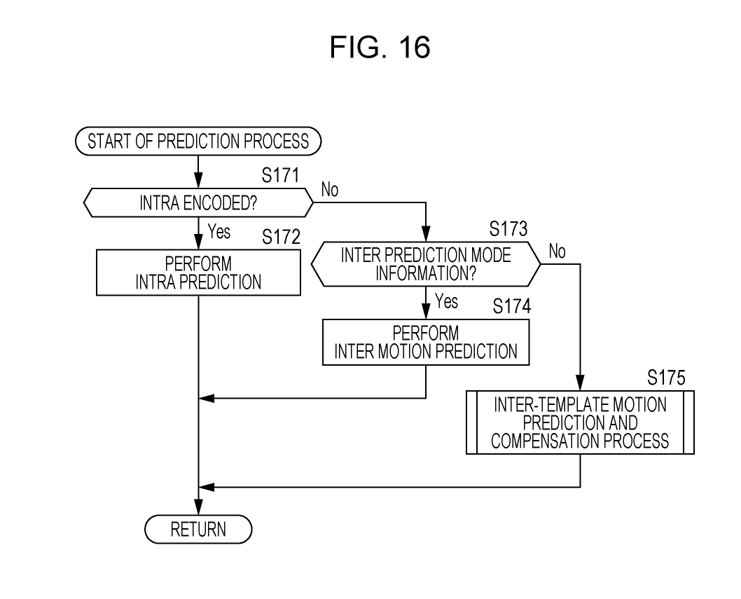

The prediction process performed in step S138 is described below with reference to FIG. 16. Through this process, the predicted image generated by the intra prediction unit 121, the predicted image generated by the motion prediction/compensation unit 122, or the predicted image generated by the template motion prediction/compensation unit 123 is supplied to the switch 125.

In step S139, the switch 125 selects the predicted image. That is, since the predicted image generated by the intra prediction unit 121, the predicted image generated by the motion prediction/compensation unit 122, or the predicted image generated by the template motion prediction/compensation unit 123 is supplied, the supplied predicted image is selected and supplied to the computing unit 115. As described above, in step S134, the predicted image is added to the output of the inverse orthogonal transform unit 114.

In step S140, the re-ordering screen buffer 117 performs a re-ordering process. That is, the order of frames that has been changed by the re-ordering screen buffer 62 of the image encoding apparatus 51 for encoding is changed back to the original display order.

In step S141, the D/A conversion unit 118 D/A-converts images supplied from the re-ordering screen buffer 117. The images are output to a display (not shown), which displays the images.

The prediction process performed in step S138 shown in FIG. 15 is described next with reference to a flowchart shown in FIG. 16.

In step S171, the intra prediction unit 121 determines whether the target block is intra coded. If intra prediction mode information is supplied from the lossless decoding unit 112 to the intra prediction unit 121, the intra prediction unit 121, in step 171, determines that the target block has been intra coded. Thus, the processing proceeds to step S172.

In step S172, the intra prediction unit 121 performs intra prediction. That is, if the image to be processed is an image to be intra processed, necessary images are read from the frame memory 119. The readout images are supplied to the intra prediction unit 121 via the switch 120. In step S172, the intra prediction unit 121 performs intra prediction in accordance with the intra prediction mode information supplied from the lossless decoding unit 112 and generates a predicted image. The generated predicted image is output to the switch 125.

However, if, in step S171, the intra prediction unit 121 determines that the target block has not been intra coded, the processing proceeds to step S173.

If the image to be processed is an image to be inter processed, the inter prediction mode information, the reference frame information, and the motion vector information are supplied from the lossless decoding unit 112 to the motion prediction/compensation unit 122. In step S173, the motion prediction/compensation unit 122 determines whether the prediction mode information supplied from the lossless decoding unit 112 is inter prediction mode information. If the motion prediction/compensation unit 122 determines that the prediction mode information is inter prediction mode information, the motion prediction/compensation unit 122 performs inter motion prediction in step S174.

If the image to be processed is an image to be subjected to an inter prediction process, necessary images are read from the frame memory 119. The readout images are supplied to the motion prediction/compensation unit 122 via the switch 120. In step S174, the motion prediction/compensation unit 122 performs motion prediction in an inter prediction mode on the basis of the motion vector supplied from the lossless decoding unit 112 and generates a predicted image. The generated predicted image is output to the switch 125.

If, in step S173, it is determined that the prediction mode information is not inter prediction mode information, that is, if it is determined that the prediction mode information is inter-template prediction mode information, the processing proceeds to step S175, where an inter-template motion prediction process is performed.

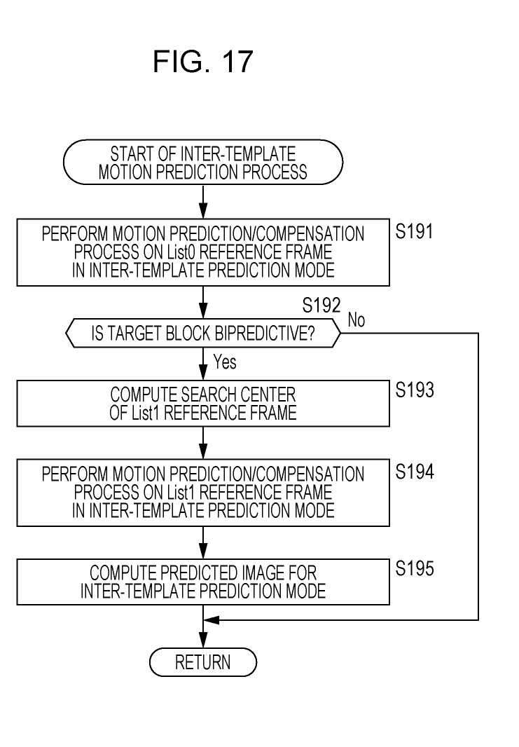

The inter-template motion prediction process performed in step S175 is described next with reference to a flowchart shown in FIG. 17. Note that the processes performed in steps S191 to S195 shown in FIG. 17 are substantially the same as those performed in steps S71 to S75 shown in FIG. 11. Accordingly, detailed descriptions thereof are not repeated.

If the image to be processed is an image to be subjected to an inter-template prediction process, necessary images are read from the frame memory 119. The readout images are supplied to the template motion prediction/compensation unit 123 via the switch 120 and the motion prediction/compensation unit 122.

In step S191, the template motion prediction/compensation unit 123 performs a motion prediction/compensation process in the inter-template prediction mode for the List0 reference frame. That is, the template motion prediction/compensation unit 123 searches for a motion vector for the List0 reference frame using the inter-template matching method. Thereafter, the template motion prediction/compensation unit 123 performs a motion prediction and compensation process on the reference image on the basis of the searched motion vector and generates a predicted image.

In step S192, the template motion prediction/compensation unit 123 determines whether the target block currently being encoded is bipredictive. If, in step S192, it is determined that the target block is bipredictive, the template motion prediction/compensation unit 123, in step S193, instructs the L1 search center computing unit 124 to compute the search center in the L1 reference frame. Thereafter, in step S194, the template motion prediction/compensation unit 123 performs a motion search within a predetermined area around the search center of the L1 reference frame computed by the L1 search center computing unit 124 and performs a compensation process. Thus, the template motion prediction/compensation unit 123 generates a predicted image.

In step S195, the template motion prediction/compensation unit 123 computes a predicted image of the target block in the inter-template mode using the predicted images for the L0 and L1 reference frames computed in the process performed in step S191 or S194. For example, as described above with reference to FIG. 11, the predicted image for the target block can be obtained by computing the mean value of the predicted images for the L0 and L1 reference frames or using weight prediction. The predicted image is supplied to the switch 125 via the motion prediction/compensation unit 122.

However, if, in step S192, it is determined that the target block is not bipredictive, the inter-template motion prediction process is completed. That is, in this case, the predicted image for the L0 reference frame is considered as the predicted image for the target block in the inter-template mode. The predicted image is supplied to the switch 125 via the motion prediction/compensation unit 122.

As described above, by performing the above-described motion prediction on the basis of template matching in both the image encoding apparatus and the image decoding apparatus, an image having an excellent image quality can be displayed without transferring the motion vector information and reference frame information.

In addition, when the motion prediction/compensation process in the inter-template prediction mode is performed on the B slice, the search center in the L1 reference frame is computed using the motion vector information computed for the L0 reference frame, and a motion search is performed using the search center. In this way, an increase in the amount of computation can be prevented with a minimized decrease in coding efficiency.

Furthermore, when the H.264/AVC motion prediction/compensation process is performed, prediction based on template matching is also performed. Thereafter, a better cost function value is selected, and the encoding process is performed. Accordingly, the coding efficiency can be increased.

While above description has been made with reference to a macroblock having a size of 16×16 pixels, the present invention can be applied to the extended macroblock size described in “Video Coding Using Extended Block Sizes”, VCEG-AD09, ITU-Telecommunications Standardization Sector STUDY GROUP Question 16—Contribution 123, January 2009.

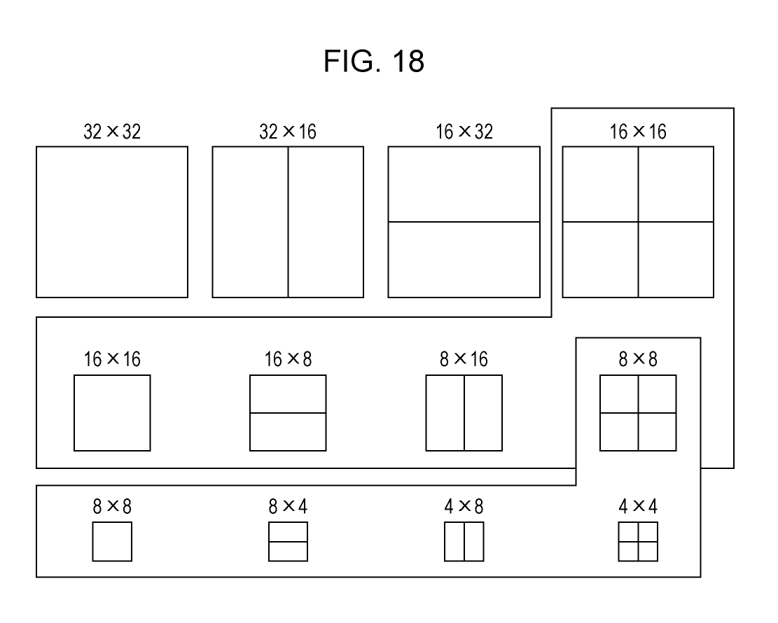

FIG. 18 illustrates an example of the extended macroblock size. In the above-described description, the macroblock size is extended to a size of 32×32 pixels.

In the upper section of FIG. 18, macroblocks that have a size of 32×32 pixels and that are partitioned into blocks (partitions) having sizes of 32×32 pixels, 32×16 pixels, 16×32 pixels, and 16×16 pixels are shown from the left. In the middle section of FIG. 18, macroblocks that have a size of 16×16 pixels and that are partitioned into blocks having sizes of 16×16 pixels, 16×8 pixels, 8×16 pixels, and 8×8 pixels are shown from the left. In the lower section of FIG. 18, macroblocks that have a size of 8×8 pixels and that are partitioned into blocks having sizes of 8×8 pixels, 8×4 pixels, 4×8 pixels, and 4×4 pixels are shown from the left.

That is, the macroblock having a size of 32×32 can be processed using the blocks having sizes of 32×32 pixels, 32×16 pixels, 16×32 pixels, and 16×16 pixels shown in the upper section of FIG. 18.

In addition, as in the H.264/AVC standard, the block having a size of 16×16 pixels shown on the left in the upper section can be processed using the blocks having sizes of 16×16 pixels, 16×8 pixels, 8×16 pixels, and 8×8 pixels shown in the middle section.

Furthermore, as in the H.264/AVC standard, the block having a size of 8×8 pixels shown on the left in the middle section can be processed using the blocks having sizes of 8×8 pixels, 8×4 pixels, 4×8 pixels, and 4×4 pixels shown in the lower section.

In terms of the extended macroblock size, by employing such a layer structure, for a block having a size smaller than or equal to 16×16 pixels, a block having a larger size can be defined as a superset of the block while maintaining compatibility with the H.264/AVC standard.

In this way, the present invention can be applied to the proposed extended macroblock size.

While above description has been described with reference to the H.264/AVC standard as an encoding method, another encoding/decoding method can be employed.

Note that the present invention is applicable to an image encoding apparatus and an image decoding apparatus used for receiving image information (a bit stream) compressed through the orthogonal transform (e.g., discrete cosine transform) and motion compensation as in the MPEG or H.26x standard via a network medium, such as satellite broadcasting, a cable TV (television), the Internet, or a cell phone or processing image information in a storage medium such as an optical or magnetic disk, or a flash memory. In addition, the present invention is applicable to a motion prediction and compensation apparatus included in such an image encoding apparatus and an image decoding apparatus.

The above-described series of processes can be executed not only by hardware but also by software. When the above-described series of processes are executed by software, the programs of the software are installed from a program recording medium into a computer incorporated into dedicated hardware or a computer that can, execute a variety of functions by installing a variety of programs therein (e.g., a general-purpose personal computer).

Examples of the program recording medium that records a computer-executable program include a magnetic disk (including a flexible disk), an optical disk (including a CD-ROM (Compact Disc-Read Only Memory), a DVD (Digital Versatile Disc), and a magnetooptical disk), a removable medium which is a package medium formed from a semiconductor memory), and a ROM and a hard disk that temporarily or permanently stores the programs. The programs are recorded in the program recording medium using a wired or wireless communication medium, such as a local area network, the Internet, or digital satellite broadcasting, as needed.

In the present specification, the steps that describe the program include not only processes executed in the above-described time-series sequence, but also processes that may be executed in parallel or independently.

In addition, embodiments of the present invention are not limited to the above-described embodiments. Various modifications can be made without departing from the spirit of the present invention.

For example, the above-described image encoding apparatus 51 and image decoding apparatus 101 are applicable to any electronic apparatus. Examples of the application is described below.

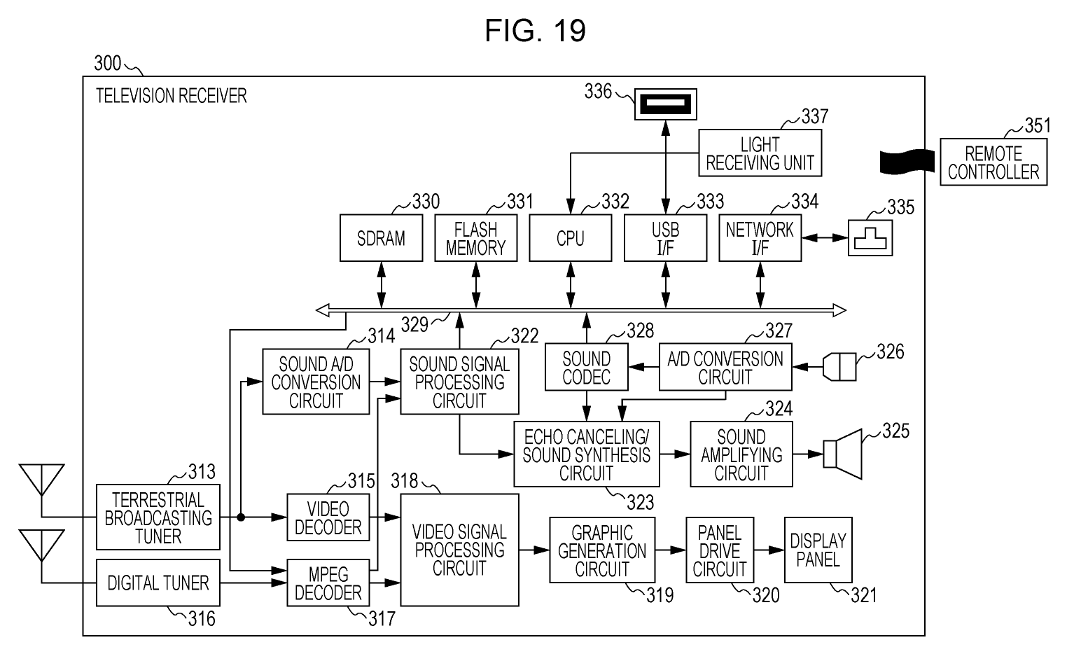

FIG. 19 is a block diagram of an example of the primary configuration of a television receiver using the image decoding apparatus according to the present invention.

As shown in FIG. 19, a television receiver 300 includes a terrestrial broadcasting tuner 313, a video decoder 315, a video signal processing circuit 318, a graphic generation circuit 319, a panel drive circuit 320, and a display panel 321.

The terrestrial broadcasting tuner 313 receives a broadcast signal of an analog terrestrial broadcasting via an antenna, demodulates the broadcast signal, acquires a video signal, and supplies the video signal to the video decoder 315. The video decoder 315 performs a decoding process on the video signal supplied from the terrestrial broadcasting tuner 313 and supplies the resultant digital component signal to the video signal processing circuit 318.

The video signal processing circuit 318 performs a predetermined process, such as noise removal, on the video data supplied from the video decoder 315. Thereafter, the video signal processing circuit 318 supplies the resultant video data to the graphic generation circuit 319.

The graphic generation circuit 319 generates, for example, video data for a television program displayed on the display panel 321 and image data generated through the processing performed by an application supplied via a network. Thereafter, the graphic generation circuit 319 supplies the generated video data and image data to the panel drive circuit 320. In addition, the graphic generation circuit 319 generates video data (graphics) for displaying a screen used by a user who selects a menu item. The graphic generation circuit 319 overlays the video data on the video data of the television program. Thus, the graphic generation circuit 319 supplies the resultant video data to the panel drive circuit 320 as needed.

The panel drive circuit 320 drives the display panel 321 in accordance with the data supplied from the graphic generation circuit 319. Thus, the panel drive circuit 320 causes the display panel 321 to display the video of a television program and a variety types of screen thereon.

The display panel 321 includes, for example, an LCD (Liquid Crystal Display). The display panel 321 displays, for example, the video of a television program under the control of the panel drive circuit 320.

The television receiver 300 further includes a sound A/D (Analog/Digital) conversion circuit 314, a sound signal processing circuit 322, an echo canceling/sound synthesis circuit 323, a sound amplifying circuit 324, and a speaker 325.

The terrestrial broadcasting tuner 313 demodulates a received broadcast signal. Thus, the terrestrial broadcasting tuner 313 acquires a sound signal in addition to the video signal. The terrestrial broadcasting tuner 313 supplies the acquired sound signal to the sound A/D conversion circuit 314.

The sound A/D conversion circuit 314 performs an A/D conversion process on the sound signal supplied from the terrestrial broadcasting tuner 313. Thereafter, the sound A/D conversion circuit 314 supplies the resultant digital sound signal to the sound signal processing circuit 322.

The sound signal processing circuit 322 performs a predetermined process, such as noise removal, on the sound data supplied from the sound A/D conversion circuit 314 and supplies the resultant sound data to the echo canceling/sound synthesis circuit 323.

The echo canceling/sound synthesis circuit 323 supplies the sound data supplied from the sound signal processing circuit 322 to the sound amplifying circuit 324.

The sound amplifying circuit 324 performs a D/A conversion process and an amplifying process on the sound data supplied from the echo canceling/sound synthesis circuit 323. After the sound data has a predetermined sound volume, the sound amplifying circuit 324 outputs the sound from the speaker 325.

The television receiver 300 further includes a digital tuner 316 and an MPEG decoder 317.

The digital tuner 316 receives a broadcast signal of digital broadcasting (terrestrial digital broadcasting and BS (Broadcasting Satellite)/CS (Communications Satellite) digital broadcasting) via an antenna and demodulates the broadcast signal. Thus, the digital tuner 316 acquires an MPEG-TS (Moving Picture Experts Group-Transport Stream) and supplies the MPEG-TS to the MPEG decoder 317.

The MPEG decoder 317 descrambles the MPEG-TS supplied from the digital tuner 316 and extracts a stream including television program data to be reproduced (viewed). The MPEG decoder 317 decodes sound packets of the extracted stream and supplies the resultant sound data to the sound signal processing circuit 322. In addition, the MPEG decoder 317 decodes video packets of the stream and supplies the resultant video data to the video signal processing circuit 318. Furthermore, the MPEG decoder 317 supplies EPG (Electronic Program Guide) data extracted from the MPEG-TS to a CPU 332 via a path (not shown).

The television receiver 300 uses the above-described image decoding apparatus 101 as the MPEG decoder 317 that decodes the video packets in this manner. Accordingly, like the image decoding apparatus 101, upon performing motion prediction/compensation process in an inter-template prediction mode for a B slice, the MPEG decoder 317 computes the search center of the L1 reference frame using the motion vector information obtained for the L0 reference frame and performs a motion search using the search center. Thus, the amount of computation can be reduced with a minimized decrease in coding efficiency.

Like the video data supplied from the video decoder 315, the video data supplied from the MPEG decoder 317 is subjected to a predetermined process in the video signal processing circuit 318. Thereafter, the video data subjected to the predetermined process is overlaid on the generated video data in the graphic generation circuit 319 as needed. The video data is supplied to the display panel 321 via the panel drive circuit 320 and is displayed.

Like the sound data supplied from the sound A/D conversion circuit 314, the sound data supplied from the MPEG decoder 317 is subjected to a predetermined process in the sound signal processing circuit 322. Thereafter, the sound data subjected to the predetermined process is supplied to the sound amplifying circuit 324 via the echo canceling/sound synthesis circuit 323 and is subjected to a D/A conversion process and an amplifying process. As a result, sound controlled so as to have a predetermined volume is output from the speaker 325.

The television receiver 300 further includes a microphone 326 and an A/D conversion circuit 327.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the echo canceling/sound synthesis circuit 323.

When voice data of a user (a user A) of the television receiver 300 is supplied from the A/D′conversion circuit 327, the echo canceling/sound synthesis circuit 323 performs echo canceling on the voice data of the user A. After echo canceling is completed, the echo canceling/sound synthesis circuit 323 synthesizes the voice data with other sound data. Thereafter, the echo canceling/sound synthesis circuit 323 outputs the resultant sound data from the speaker 325 via the sound amplifying circuit 324.

The television receiver 300 still further includes a sound codec 328, an internal bus 329, an SDRAM (Synchronous Dynamic Random Access Memory) 330, a flash memory 331, the CPU 332, a USB (Universal Serial Bus) I/F 333, and a network I/F 334.

The A/D conversion circuit 327 receives a user voice signal input from the microphone 326 provided in the television receiver 300 for speech conversation. The A/D conversion circuit 327 performs an A/D conversion process on the received voice signal and supplies the resultant digital voice data to the sound codec 328.

The sound codec 328 converts the sound data supplied from the A/D conversion circuit 327 into data having a predetermined format in order to send the sound data via a network. The sound codec 328 supplies the sound data to the network I/F 334 via the internal bus 329.

The network I/F 334 is connected to the network via a cable attached to a network terminal 335. For example, the network I/F 334 sends the sound data supplied from the sound codec 328 to a different apparatus connected to the network. In addition, for example, the network I/F 334 receives sound data sent from a different apparatus connected to the network via the network terminal 335 and supplies the received sound data to the sound codec 328 via the internal bus 329.

The sound codec 328 converts the sound data supplied from the network I/F 334 into data having a predetermined format. The sound codec 328 supplies the sound data to the echo canceling/sound synthesis circuit 323.

The echo canceling/sound synthesis circuit 323 performs echo canceling on the sound data supplied from the sound codec 328. Thereafter, the echo canceling/sound synthesis circuit 323 synthesizes the sound data with other sound data and outputs the resultant sound data from the speaker 325 via the sound amplifying circuit 324.

The SDRAM 330 stores a variety of types of data necessary for the CPU 332 to perform processing.

The flash memory 331 stores a program executed by the CPU 332. The program stored in the flash memory 331 is read out by the CPU 332 at a predetermined timing, such as when the television receiver 300 is started. The flash memory 331 further stores the EPG data received through digital broadcasting and data received from a predetermined server via the network.

For example, the flash memory 331 stores an MPEG-TS including content data acquired from a predetermined server via the network under the control of the CPU 332. The flash memory 331 supplies the MPEG-TS to the MPEG decoder 317 via the internal bus 329 under the control of, for example, the CPU 332.

As in the case of the MPEG-TS supplied from the digital tuner 316, the MPEG decoder 317 processes the MPEG-TS. In this way, the television receiver 300 receives content data including video and sound via the network and decodes the content data using the MPEG decoder 317. Thereafter, the television receiver 300 can display the video and output the sound.

The television receiver 300 still further includes a light receiving unit 337 that receives an infrared signal transmitted from a remote controller 351.

The light receiving unit 337 receives and demodulates an infrared light beam emitted from the remote controller 351. Thereafter, the light receiving unit 337 outputs control code indicating the type of the user operation to the CPU 332.

The CPU 332 executes the program stored in the flash memory 331 and performs overall control of the television receiver 300 in accordance with, for example, the control code supplied from the light receiving unit 337. The CPU 332 is connected to each of the units of the television receiver 300 via a path (not shown).

The USB I/F 333 communicates data with an external device connected to the television receiver 300 via a USB cable attached to a USB terminal 336. The network I/F 334 is connected to the network via a cable attached to the network terminal 335 and communicates non-sound data with a variety of types of device connected to the network.

By using the image decoding apparatus 101 as the MPEG decoder 317, the television receiver 300 can reduce the amount of computation with a minimized decrease in coding efficiency. As a result, the television receiver 300 can acquire a higher-resolution decoded image from the broadcast signal received via the antenna or content data received via the network at higher speed and display the decoded image.

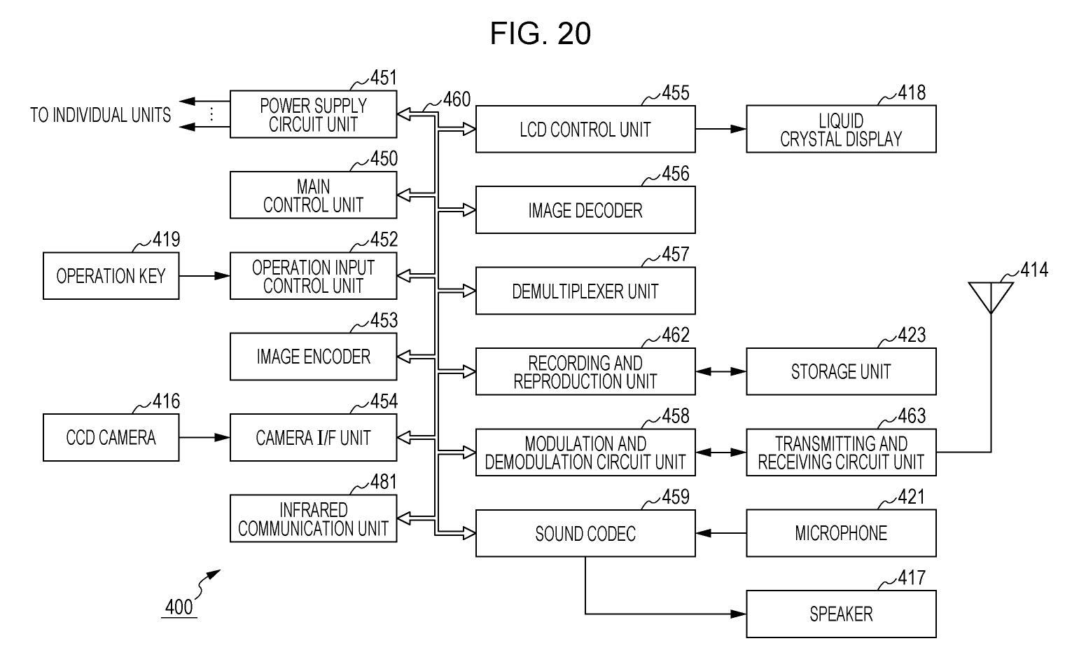

FIG. 20 is a block diagram of an example of a primary configuration of a cell phone using the image encoding apparatus and the image decoding apparatus according to the present invention.

As shown in FIG. 20, a cell phone 400 includes a main control unit 450 that performs overall control of units thereof, a power supply circuit unit 451, an operation input control unit 452, an image encoder 453, a camera I/F unit 454, an LCD control unit 455, an image decoder 456, a demultiplexer unit 457, a recording and reproduction unit 462, a modulation and demodulation circuit unit 458, and a sound codec 459. These units are connected to one another via a bus 460.

The cell phone 400 further includes an operation key 419, a CCD (Charge Coupled Devices) camera 416, a liquid crystal display 418, a storage unit 423, a transmitting and receiving circuit unit 463, an antenna 414, a microphone (MIC) 421, and a speaker 417.

When call-ending is performed through a user operation or a power key is turned on, the power supply circuit unit 451 supplies the power from a battery pack to each unit. Thus, the cell phone 400 becomes operable.

Under the control of the main control unit 450 including a CPU, a ROM, and a RAM, the cell phone 400 performs a variety of operations, such as transmitting and receiving a voice signal, transmitting and receiving an e-mail and an image data, and data recording, in a variety of modes, such as a voice communication mode and a data communication mode.

For example, in the voice communication mode, the cell phone 400 converts a voice signal collected by the microphone (MIC) 421 into digital voice data using the sound codec 459. Thereafter, the cell phone 400 performs a spread spectrum process on the digital voice data using a modulation and demodulation circuit unit 458 and performs a digital-to-analog conversion process and a frequency conversion process on the digital voice data using the transmitting and receiving circuit unit 463. The cell phone 400 transmits a transmission signal obtained through the conversion process to a base station (not shown) via the antenna 414. The transmission signal (the voice signal) transmitted to the base station is supplied to a cell phone at a receiving end via a public telephone network.

In addition, for example, in the voice communication mode, the cell phone 400 amplifies a reception signal received by the antenna 414 using the transmitting and receiving circuit unit 463 and further performs a frequency conversion process and a analog-to-digital conversion process on the reception signal. The cell phone 400 further performs an inverse spread spectrum process on the reception signal using the modulation and demodulation circuit unit 458 and converts the reception signal into an analog voice signal using the sound codec 459. Thereafter, the cell, phone 400 outputs the converted analog voice signal from the speaker 417.

Furthermore, for example, upon sending an e-mail in the data communication mode, the cell phone 400 receives text data of an e-mail input through operation of the operation key 419 using the operation input control unit 452. Thereafter, the cell phone 400 processes the text data using the main control unit 450 and displays the text data on the liquid crystal display 418 via the LCD control unit 455 in the form of an image.

Still furthermore, the cell phone 400 generates, using the main control unit 450, e-mail data on the basis of the text data and the user instruction received by the operation input control unit 452. Thereafter, the cell phone 400 performs a spread spectrum process on the e-mail data using the modulation and demodulation circuit unit 458 and performs a digital-to-analog conversion process and a frequency conversion process using the transmitting and receiving circuit unit 463. The cell phone 400 transmits a transmission signal obtained through the conversion processes to a base station (not shown) via the antenna 414. The transmission signal (the e-mail) transmitted to the base station is supplied to a predetermined address via a network and a mail server.

In addition, for example, in order to receive an e-mail in the data communication mode, the cell phone 400 receives a signal transmitted from the base station via the antenna 414 using the transmitting and receiving circuit unit 463, amplifies the signal, and further performs a frequency conversion process and an analog-to-digital conversion process on the signal. The cell phone 400 performs an inverse spread spectrum process on the reception signal and restores the original e-mail data using the modulation and demodulation circuit unit 458. The cell phone 400 displays the restored e-mail data on the liquid crystal display 418 via the LCD control unit 455.

Furthermore, the cell phone 400 can record (store) the received e-mail in the storage unit 423 via the recording and reproduction unit 462.

The storage unit 423 is formed from any rewritable storage medium. For example, the storage unit 423 may be formed from a semiconductor memory, such as a RAM or an internal flash memory, or a removable memory, such as a hard disk, a magnetic disk, a magnetooptical disk, an optical disk, a USE memory, or a memory card. However, it should be appreciated that another type of storage medium can be employed.

Still furthermore, in order to transmit image data in the data communication mode, the cell phone 400 generates image data through an image capturing operation performed by the CCD camera 416. The CCD camera 416 includes optical devices, such as a lens and an aperture, and a CCD serving as a photoelectric conversion element. The CCD camera 416 captures the image of a subject, converts the intensity of the received light into an electrical signal, and generates the image data of the subject image. The CCD camera 416 supplies the image data to the image encoder 453 via the camera I/F unit 454. The image encoder 453 compression-encodes the image data using a predetermined coding standard, such as MPEG2 or MPEG4, and converts the image data into encoded image data.

The cell phone 400 employs the above-described image encoding apparatus 51 as the image encoder 453 that performs such a process. Accordingly, like the image encoding apparatus 51, upon performing motion prediction/compensation process in an inter-template prediction mode for a B slice, the image encoder 453 computes the search center of the L1 reference frame using the motion vector information obtained for the L0 reference frame and performs a motion search using the search center. Thus, the amount of computation can be reduced with a minimized decrease in coding efficiency.

Note that at the same time, the cell phone 400 analog-to-digital converts the sound collected by the microphone (MIC) 421 during the image capturing operation performed by the CCD camera 416 using the sound codec 459 and further performs an encoding process.

The cell phone 400 multiplexes, using the demultiplexer unit 457, the encoded image data supplied from the image encoder 453 with the digital sound data supplied from the sound codec 459 using a predetermined technique. The cell phone 400 performs a spread spectrum process on the resultant multiplexed data using the modulation and demodulation circuit unit 458 and performs a digital-to-analog conversion process and a frequency conversion process using the transmitting and receiving circuit unit 463. The cell phone 400 transmits a transmission signal obtained through the conversion processes to the base station (not shown) via the antenna 414. The transmission signal (the image data) transmitted to the base station is supplied to a communication partner via, for example, the network.

Note that if image data is not transmitted, the cell phone 400 can display the image data generated by the CCD camera 416 on the liquid crystal display 418 via the LCD control unit 455 without using the image encoder 453.

In addition, for example, in order to receive the data of a moving image file linked to, for example, a simplified Web page in the data communication mode, the cell phone 400 receives a signal transmitted from the base station via the antenna 414 using the transmitting and receiving circuit unit 463, amplifies the signal, and further performs a frequency conversion process and a digital-to-analog conversion process on the signal. The cell phone 400 performs an inverse spread spectrum process on the reception signal using the modulation and demodulation circuit unit 458 and restores the original multiplexed data. The cell phone 400 demultiplexes the multiplexed data into the encoded image data and sound data using the demultiplexer unit 457.

By decoding the encoded image data in the image decoder 456 using a predetermined encoding standard, such as MPEG2 or MPEG4, the cell phone 400 can generate reproduction image data and displays the reproduction image data on the liquid crystal display 418 via the LCD control unit 455. Thus, for example, moving image data included in a moving image file linked to a simplified Web page can be displayed on the liquid crystal display 418.

The cell phone 400 employs the above-described image decoding apparatus 101 as the image decoder 456 that performs such a process. Accordingly, like the image decoding apparatus 101, upon performing motion prediction/compensation process in an inter-template prediction mode for a B slice, the image decoder 456 computes the search center of the L1 reference frame using the motion vector information obtained for the L0 reference frame and performs a motion search using the search center. Thus, the amount of computation can be reduced with a minimized decrease in coding efficiency.

At the same time, the cell phone 400 converts the digital sound data into an analog sound signal using the sound codec 459 and outputs the analog sound signal from the speaker 417. In this way, for example, the sound data included in the moving image file linked to the simplified Web page can be reproduced.

Note that as in the case of an e-mail, the cell phone 400 can record (store) the data linked to, for example, a simplified Web page in the storage unit 423 via the recording and reproduction unit 462.

In addition, the cell phone 400 can analyze a two-dimensional code obtained through an image capturing operation performed by the CCD camera 416 using the main control unit 450 and acquire the information recorded as the two-dimensional code.

Furthermore, the cell phone 400 can communicate with an external device using an infrared communication unit 481 and infrared light.

By using the image encoding apparatus 51 as the image encoder 453, the cell phone 400 can increase the processing speed and the coding efficiency for encoding, for example, the image data generated by the CCD camera 416 and generating image data. As a result, the cell phone 400 can provide encoded data (image data) with excellent coding efficiency to another apparatus.

In addition, by using the image decoding apparatus 101 as the image decoder 456, the cell phone 400 can increase the processing speed and generate a high-accuracy predicted image. As a result, the cell phone 400 can acquire a higher-resolution decoded image from a moving image file linked to the simplified Web page and display the higher-resolution decoded image.

Note that while the above description has been made with reference to the cell phone 400 using the CCD camera 416, an image sensor using a CMOS (Complementary Metal Oxide Semiconductor) (i.e., a CMOS image sensor) may be used in stead of the CCD camera 416. Even in such a case, as in the case of using the CCD camera 416, the cell phone 400 can capture the image of a subject and generate the image data of the image of the subject.

In addition, while the above description has been made with reference to the cell phone 400, the image encoding apparatus 51 and the image decoding apparatus 101 can be applied to any apparatus having an image capturing function and a communication function similar to those of the cell phone 400, such a PDA (Personal Digital Assistant), a smart phone, a UMPC (Ultra Mobile Personal Computer), a netbook, or a laptop personal computer, as to the cell phone 400.

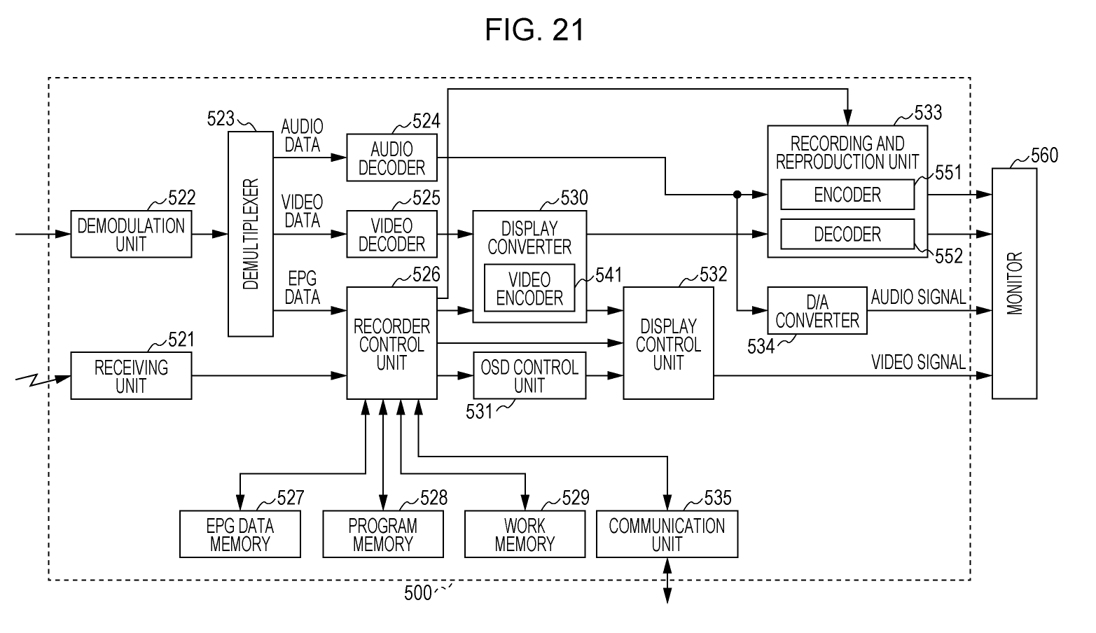

FIG. 21 is a block diagram of an example of the primary configuration of a hard disk recorder using the image encoding apparatus and the image decoding apparatus according to the present invention.

As shown in FIG. 21, a hard disk recorder (HDD recorder) 500 stores, in,an internal hard disk, audio data and video data of a broadcast program included in a broadcast signal (a television program) emitted from, for example, a satellite or a terrestrial antenna and received by a tuner. Thereafter, the hard disk recorder 500 provides the stored data to a user at a timing instructed by the user.

The hard disk recorder 500 can extract, from, for example, the broadcast signal, audio data and video data, decode the data as needed, and store the data in the internal hard disk. In addition, the hard disk recorder 500 can acquire audio data and video data from another apparatus via, for example, a network, decode the data as needed, and store the data in the internal hard disk.

Furthermore, the hard disk recorder 500 can decode audio data and video data stored in, for example, the internal hard disk, decode the audio data and video data, and supply the decoded audio data and video data to a monitor 560. Thus, the image can be displayed on the screen of the monitor 560. In addition, the hard disk recorder 500 can output the sound from a speaker of the monitor 560.

For example, the hard disk recorder 500 decodes audio data and video data extracted from the broadcast signal received via the tuner or audio data and video data acquired from another apparatus via a network. Thereafter, the hard disk recorder 500 supplies the decoded audio data and video data to the monitor 560, which displays the audio data and video data on the screen thereof. In addition, the hard disk recorder 500 can output the sound from the speaker of the monitor 560.

It should be appreciated that the hard disk recorder 500 can perform other operations.

As shown in FIG. 21, the hard disk recorder 500 includes a receiving unit 521, a demodulation unit 522, a demultiplexer 523, an audio decoder 524, a video decoder 525, and a recorder control unit 526. The hard disk recorder 500 further includes an EPG data memory 527, a program memory 528, a work memory 529, a display converter 530, an OSD (On Screen Display) control unit 531, a display control unit 532, a recording and reproduction unit 533, a D/A converter 534, and a communication unit 535.

Furthermore, the display converter 530 includes a video encoder 541. The recording and reproduction unit 533 includes an encoder 551 and a decoder 552.

The receiving unit 521 receives an infrared signal transmitted from a remote controller (not shown) and converts the infrared signal into an electrical signal. Thereafter, the receiving unit 521 outputs the electrical signal to the recorder control unit 526. The recorder control unit 526 is formed from, for example, a microprocessor. The recorder control unit 526 performs a variety of processes in accordance with a program stored in the program memory 528. At that time, the recorder control unit 526 uses the work memory 329 as needed.

The communication unit 535 is connected to a network and performs a communication process with another apparatus connected thereto via the network. For example, the communication unit 535 is controlled by the recorder control unit 526 and communicates with a tuner (not shown). The communication unit 535 mainly outputs a channel tuning control signal to the tuner.

The demodulation unit 522 demodulates the signal supplied from the tuner and outputs the signal to the demultiplexer 523. The demultiplexer 523 separates the data supplied from the demodulation unit 522 into audio data, video data, and EPG data and outputs these data items to the audio decoder 524, the video decoder 525, and the recorder control unit 526, respectively.

The audio decoder 524 decodes the input audio data using, for example, the MPEG standard and outputs the audio data to the recording and reproduction unit 533. The video decoder 525 decodes the input video data using, for example, the MPEG standard and outputs the video data to the display converter 530. The recorder control unit 526 supplies the input EPG data to, the EPG data memory 527, which stores the EPG data.

The display converter 530 encodes the video data supplied from the video decoder 525 or the recorder control unit 526 into, for example, NTSC (National Television Standards Committee) video data using the video encoder 541 and outputs the video data to the recording and reproduction unit 533. In addition, the display converter 530 converts the screen size for the video data supplied from the video decoder 525 or the recorder control unit 526 into the size corresponding to the monitor 560. The display converter 530 further converts the video data having the converted screen size into NTSC video data using the video encoder 541 and converts the video data into an analog signal. Thereafter, the display converter 530 outputs the analog signal to the display control unit 532.

Under the control of the recorder control unit 526, the display control unit 532 overlays an OSD signal output from the OSD (On Screen Display) control unit 531 on a video signal input from the display converter 530 and outputs the overlaid signal to the monitor 560, which displays the image.

In addition, the audio data output from the audio decoder 524 is converted into an analog signal by the D/A converter 534 and is supplied to the monitor 560. The monitor 560 outputs the audio signal from a speaker incorporated therein.

The recording and reproduction unit 533 includes a hard disk as a storage medium for recording video data and audio data.

For example, the recording and reproduction unit 533 MPEG-encodes the audio data supplied from the audio decoder 524 using the encoder 551. In addition, the recording and reproduction unit 533 MPEG-encodes the video data supplied from the video encoder 541 of the display converter 530 using the encoder 551. The recording and reproduction unit 533 multiplexes the encoded audio data with the encoded video data using a multiplexer so as to synthesize the data. The recording and reproduction unit 533 amplifies the synthesized data by channel coding and writes the data into the hard disk via a recording head.

The recording and reproduction unit 533 reproduces the data recorded in the hard disk via a reproducing head, amplifies the data, and separates the data into audio data and video data using the demultiplexer. The recording and reproduction unit 533 MPEG-decodes the audio data and video data using the decoder 552. The recording and reproduction unit 533 D/A-converts the decoded audio data and outputs the converted audio data to the speaker of the monitor 560. In addition, the recording and reproduction unit 533 D/A-converts the decoded video data and outputs the converted video data to the display of the monitor 560.

The recorder control unit 526 reads the latest EPG data from the EPG data memory 527 on the basis of the user instruction indicated by an infrared signal emitted from the remote controller and received via the receiving unit 521. Thereafter, the recorder control unit 526 supplies the EPG data to the OSD control unit 531. The OSD control unit 531 generates image data corresponding to the input EPG data and outputs to the display control unit 532. The display control unit 532 outputs the video data input from the OSD control unit 531 on the display of the monitor 560, which displays the video data. In this way, the EPG (electronic program guide) is displayed on the display of the monitor 560.

In addition, the hard disk recorder 500 can acquire a variety of types of data, such as video data, audio data, or EPG data, supplied from a different apparatus via a network, such as the Internet.

The communication unit 535 is controlled by the recorder control unit 526. The communication unit 535 acquires encoded data, such as video data, audio data, and EPG data, transmitted from a different apparatus via a network and supplies the encoded data to the recorder control unit 526. The recorder control unit 526 supplies, for example, the acquired encoded video data and audio data to the recording and reproduction unit 533, which stores the data in the hard disk. At that time, the recorder control unit 526 and the recording and reproduction unit 533 may re-encode the data as needed.

In addition, the recorder control unit 526 decodes the acquired encoded video data and audio data and supplies the resultant video data to the display converter 530. Like the video data supplied from the video decoder 525, the display converter 530 processes the video data supplied from the recorder control unit 526 and supplies the video data to the monitor 560 via the display control unit 532 so that the image is displayed.

At the same time as displaying the image, the recorder control unit 526 may supply the decoded audio data to the monitor 560 via the D/A converter 534 and output the sound from the speaker.

Furthermore, the recorder control unit 526 decodes the acquired encoded EPG data and supplies the decoded EPG data to the EPG data memory 527.

The above-described hard disk recorder 500 uses the image decoding apparatus 101 as each of the decoders included in the video decoder 525, the decoder 552, and the recorder control unit 526. Accordingly, like the image decoding apparatus 101, upon performing motion prediction/compensation process in an inter-template prediction mode for a B slice, the decoder included in each of the decoders included in the video decoder 525, the decoder 552, and the recorder control unit 526 computes the search center of the L1 reference frame using the motion vector information obtained for the L0 reference frame and performs a motion search using the search center. Thus, the amount of computation can be reduced with a minimized decrease in coding efficiency.

Therefore, the hard disk recorder 500 can increase the processing speed and generate a high-accuracy predicted image. As a result, the hard disk recorder 500 can acquire a higher-resolution decoded image from encoded video data received via the tuner, encoded video data read from the hard disk of the recording and reproduction unit 533, or encoded video data acquired via the network and display the higher-resolution decoded image on the monitor 560.

In addition, the hard disk recorder 500 uses the image encoding apparatus 51 as the encoder 551. Accordingly, like the image encoding apparatus 51, upon performing motion prediction/compensation process in an inter-template prediction mode for a B slice, the encoder 551 computes the search center of the L1 reference frame using the motion vector information obtained for the L0 reference frame and performs a motion search using the search center. Thus, the amount of computation can be reduced with a minimized decrease in coding efficiency.

Accordingly, for example, the hard disk recorder 500 can increase the processing speed and increase the coding efficiency for the encoded data stored in the hard disk. As a result, the hard disk recorder 500 can use the storage area of the hard disk more efficiently.

Note that while the above description has been made with reference to the hard disk recorder 500 that records video data and audio data in the hard disk, it should be appreciated that any recording medium can be employed. For example, like the above-described hard disk recorder 500, the image encoding apparatus 51 and the image decoding apparatus 101 can be applied even to a recorder that uses a recording medium other than a hard disk (e.g., a flash memory, an optical disk, or a video tape).

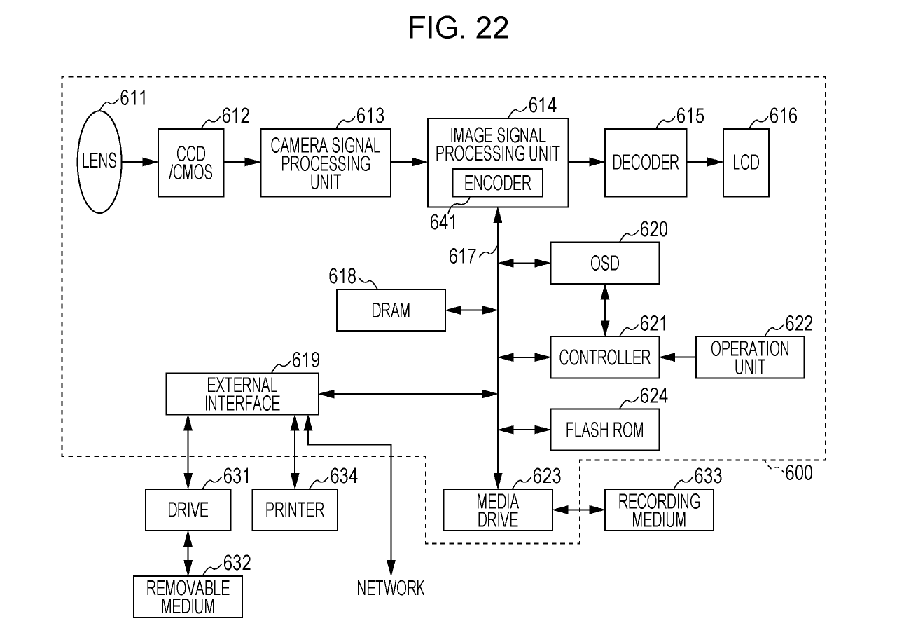

FIG. 22 is a block diagram of an example of the primary configuration of a camera using the image decoding apparatus and the image encoding apparatus according to the present invention.

A camera 600 shown in FIG. 22 captures the image of a subject and instructs an LCD 616 to display the image of the subject thereon or stores the image in a recording medium 633 in the form of image data.

A lens block 611 causes the light (i.e., the video of the subject) to be incident on a CCD/CMOS 612. The CCD/CMOS 612 is an image sensor using a CCD or a CMOS. The CCD/CMOS 612 converts the intensity of the received light into an electrical signal and supplies the electrical signal to a camera signal processing unit 613.

The camera signal processing unit 613 converts the electrical signal supplied from the CCD/CMOS 612 into Y, Cr, Cb color difference signals and supplies the color difference signals to an image signal processing unit 614. Under the control of a controller 621, the image signal processing unit 614 performs a predetermined image process on the image signal supplied from the camera signal processing unit 613 or encodes the image signal using an encoder 611 and, for example, the MPEG standard. The image signal processing unit 614 supplies encoded data generated by encoding the image signal to a decoder 615. In addition, the image signal processing unit 614 acquires display data generated by an on screen display (OSD) 620 and supplies the display data to the decoder 615.

In the above-described processing, the camera signal processing unit 613 uses a DRAM (Dynamic Random Access Memory) 618 connected thereto via a bus 617 as needed and stores, in the DRAM 618, encoded data obtained by encoding the image data as needed.

The decoder 615 decodes the encoded data supplied from the image signal processing unit 614 and supplies the resultant image data (the decoded image data) to the LCD 616. In addition, the decoder 615 supplies the display data supplied from the image signal processing unit 619 to the LCD 616. The LCD 616 combines the decoded image data supplied from the decoder 615 with the display data as needed and displays the combined image.

Under the control of the controller 621, the on screen display 620 outputs the display data, such as a menu screen including symbols, characters, or graphics and icons, to the image signal processing unit 614 via the bus 617.

The controller 621 performs a variety of types of processing on the basis of a signal indicating a user instruction input through the operation unit 622 and controls the image signal processing unit 614, the DRAM 618, an external interface 619, the on screen display 620, and a media drive 623 via the bus 617. A FLASH ROM 624 stores a program and data necessary for the controller 621 to perform the variety of types of processing.

For example, the controller 621 can encode the image data stored in the DRAM 618 and decode the encoded data stored in the DRAM 618 in stead of the image signal processing unit 614 and the decoder 615. At that time, the controller 621 may perform the encoding/decoding process using the encoding/decoding method employed by the image signal processing unit 614 and the decoder 615. Alternatively, the controller 621 may perform the encoding/decoding process using an encoding/decoding method different from that employed by the image signal processing unit 614 and the decoder 615.

In addition, for example, when instructed to print an image from the operation unit 622, the controller 621 reads the encoded data from the DRAM 618 and supplies, via the bus 617, the encoded data to a printer 634 connected to the external interface 619 via the external interface 619. Thus, the image data is printed.

Furthermore, for example, when instructed to record an image from the operation unit 622, the controller 621 reads the encoded data from the DRAM 618 and supplies, via the bus 617, the encoded data to the recording medium 633 mounted in the media drive 623. Thus, the image data is stored in the recording medium 633.

Examples of the recording medium 633 include readable and writable removable media, such as a magnetic disk, a magnetooptical disk, an optical disk, and a semiconductor memory. It should be appreciated that the recording medium 633 is of any type of removable medium, such as a tape device, a disk, or a memory card. Alternatively, the recording medium 633 may be a non-contact IC card.

Alternatively, the media drive 623 may be integrated into the recording medium 633. For example, like an internal hard disk or an SSD (Solid State Drive), a non-removable storage medium can be used as the media drive 623 and the recording medium 633.

The external interface 619 is formed from, for example, a USB input/output terminal. When an image is printed, the external interface 619 is connected to the printer 634. In addition, a drive 631 is connected to the external interface 619 as needed. Thus, a removable medium 632, such a magnetic disk, an optical disk, or a magnetooptical disk, is attached as needed. A computer program read from the removable medium 632 is installed in the FLASH ROM 624 as needed.

Furthermore, the external interface 619 includes a network interface connected to a predetermined network, such as a LAN or the Internet. For example, in response to an instruction from the operation unit 622, the controller 621 can read the encoded data from the DRAM 618 and supply the encoded data from the external interface 619 to another apparatus connected thereto via the network. In addition, the controller 621 can acquire, using the external interface 619, encoded data and image data supplied from another apparatus via the network and store the data in the DRAM 618 or supply the data to the image signal processing unit 614.

The above-described camera 600 uses the image decoding apparatus 101 as the decoder 615. Accordingly, like the image decoding apparatus 101, upon performing motion prediction/compensation process in an inter-template prediction mode for a B slice, the decoder 615 computes the search center of the L1 reference frame using the motion vector information obtained for the L0 reference frame and performs a motion search using the search center. Thus, the amount of computation can be reduced with a minimized decrease in coding efficiency.

Therefore, the above-described camera 600 can increase the processing speed and generate a high-accuracy predicted image. As a result, the camera 600 can acquire a higher-resolution decoded image from, for example, the image data generated by the CCD/CMOS 612, the encoded data of video data read from the DRAM 618 or the recording medium 633, or the encoded data of video data received via a network and display the decoded image on the LCD 616.

In addition, the camera 600 uses the image encoding apparatus 51 as the encoder 641. Accordingly, like the image encoding apparatus 51, upon performing motion prediction/compensation process in an inter-template prediction mode for a B slice, the encoder 641 computes the search center of the L1 reference frame using the motion vector information obtained for the L0 reference frame and performs a motion search using the search center. Thus, the amount of computation can be reduced with a minimized decrease in coding efficiency.

Accordingly, for example, the camera 600 can increase the processing speed and increase the coding efficiency for the encoded data stored in the hard disk. As a result, the camera 600 can use the storage area of the DRAM 618 and the storage area of the recording medium 633 more efficiently.

Note that the decoding technique employed by the image decoding apparatus 101 may be applied to the decoding process performed by the controller 621. Similarly, the encoding technique employed by the image encoding apparatus 51 may be applied to the encoding process performed by the controller 621.

In addition, the image data captured by the camera 600 may be a moving image or a still image.

It should be appreciated that the image encoding apparatus 51 and the image decoding apparatus 101 are applicable to apparatuses or systems other than the above-described apparatus.

### REFERENCE SIGNS LIST

51 image encoding apparatus

66 lossless encoding unit

74 intra prediction unit

75 motion prediction/compensation unit

76 template motion prediction/compensation unit

77 L1 search center computing unit

78 predicted image selecting unit

101 image decoding apparatus

112 lossless decoding unit

121 intra prediction unit

122 motion prediction/compensation unit

123 template motion prediction/compensation unit

124 L1 search center computing unit

125 switch

1. An image processing apparatus comprising:
a motion prediction unit configured to search for a motion vector of a first target block of a frame using a template that is adjacent to the first target block with a predetermined positional relationship and that is generated from a decoded image; and
a search center computing unit configured to compute a search center of a List1 reference frame using motion vector information regarding the first target block searched for in a List0 reference frame by the motion prediction unit and time distance information between the frame and the List0 reference frame and between the frame and the List1 reference frame;
wherein the motion prediction unit searches, using the template, for the motion vector of the first target block within a predetermined search area around the search center of the List1 reference frame computed by the search center computing unit.

2. The image processing apparatus according to claim 1, wherein the search center computing unit computes the search center of the List1 reference frame by scaling the motion vector information regarding the first target block searched for in the List0 reference frame by the motion prediction unit in accordance with the time distance information between the frame and the List0 reference frame and between the frame and the List1 reference frame.

3. The image processing apparatus according to claim 2, wherein the search center computing unit computes the search center of the List1 reference frame by rounding off the scaled motion vector information regarding the first target block to an integer pixel accuracy.

4. The image processing apparatus according to claim 2, wherein POC (Picture Order Count) is used as the time distance information.

5. The image processing apparatus according to claim 2, further comprising:
a decoding unit configured to decode encoded motion vector information; and
a second motion prediction compensation unit configured to generate a predicted image using a motion vector of a second target block of the frame decoded by the decoding unit.

6. The image processing apparatus according to claim 2, further comprising:
an image selection unit;
wherein the motion prediction unit searches for a motion vector of a second target block of the frame using the second target block, and wherein the image selection unit selects one of a predicted image based on the motion vector of the first target block searched for by the motion prediction unit and a predicted image based on the motion vector of the second target block searched for by the motion prediction unit.

7. An image processing method for use in an image processing apparatus, the method comprising:
a motion prediction step of searching for a motion vector of a target block of'a frame using a template that is adjacent to the target block with a predetermined positional relationship and that is generated from a decoded image; and
a search center computing step of computing a search center of a List1 reference frame using motion vector information regarding the target block searched for in a List0 reference frame by the motion prediction unit and time distance information between the frame and the List0 reference frame and between the frame and the List1 reference frame;
wherein in the motion prediction step, the motion vector of the target block is searched for within a predetermined search area around the computed search center of the List1 reference frame using the template.
